(19) United States
(12) Patent Application Publication
(10) Pub. No.: US 2026/0331452 A1
(43) Pub. Date: Oct. 22, 2026

(54) METHOD OF SCHEDULING IONS FOR ANALYSIS

(71) Applicants: Thermo Fisher Scientific (Bremen) GmbH, Bremen (DE); Thermo Finnigan LLC, San Jose, CA (US)

(72) Inventors: Hamish Stewart, Bremen (DE); Alexander Makarov, Bremen (DE); Michael Senko, Sunnyvale, CA (US); Graeme McAlister, San Jose, CA (US)

(21) Appl. No.: 19/638,146

(22) Filed: Apr. 3, 2026

Related U.S. Application Data
(60) Provisional application No. 63/782,864, filed on Apr. 3, 2025.

(51) Int. Cl. H01J 49/42; H01J 49/00

(52) U.S. Cl. CPC H01J 49/427; H01J 49/0031; H01J 49/004; H01J 49/4215

(57) ABSTRACT

A method of scheduling ions for analysis over a mass to charge (m/z) range of interest is provided. The method comprises:
obtaining a list of ion intensities and associated m/z for the ions to be analysed;
obtaining a plurality of target m/z or plurality of target m/z ranges to be analysed;
assigning each target m/z or target m/z range to a first group or a second group based on the list of ion intensities and associated m/z of the ions and an intensity threshold, wherein the target m/z or target m/z ranges in the first group are associated with higher intensity ions than the target m/z or target m/z ranges in the second group;
using an ion selection device to sequentially select and output ions having target m/z or target m/z ranges assigned to the first group for analysis; and
using an ion selection device to sequentially select and output ions having target m/z or target m/z ranges assigned to the second group for analysis.

### CROSS REFERENCE TO RELATED APPLICATION

This patent application claims the benefit of priority to United States Provisional Patent Application Ser. No. 63/782,864, filed on Apr. 3, 2025, which is hereby incorporated by reference herein in its entirety.

### FIELD OF THE DISCLOSURE

The present disclosure relates to mass spectrometry. In particular, the present disclosure relates to a method of ion scheduling.

### BACKGROUND

U.S. Pat. No. 2,939,952 discloses a tandem mass spectrometer which employs a quadrupole mass filter to isolate target ions prior to fragmentation and further downstream mass analysis. One feature of the quadrupole mass filter is that unselected ions strike the quadrupole rods of the quadrupole mass filter, losing precious analyte ions whilst also contaminating and eventually degrading the electrodes. Depending on the isolation windows employed, the loss of theoretical sensitivity may easily exceed 99%.

One workaround is to accumulate and separate ions in advance (upstream) of the quadrupole, so that the ion m/z delivered to the device approximately matches the range of the isolation window and ion losses are consequently minimized to the accuracy of the pre-separation. Residual losses then become a factor of the resolution of the pre-separation and the quality of the alignment to the quadrupole isolation window.

The method was first described by Hoyes in GB-A-2442638, whereby ions were first loaded into an ion trap. An RF pseudopotential barrier would prevent release of ions of higher m/z, unless overcome by a DC or travelling wave pushing them towards to exit, whereupon they would be released for quadrupole selection/fragmentation etc. Giles in U.S. Pat. No. 6,914,241B and Bateman U.S. Pat. No. 6,838,662 further describe a method of using an opposed travelling wave and non-linear DC gradients to cause separation of ions within a guide. These reach equilibrium positions and may, by adjusting the DC or travelling wave amplitude, then be released in a time dependent manner through a quadrupole, greatly boosting its efficiency. FIG. 1 illustrates ion separation under these two opposing forces, while FIG. 2 shows a schematic diagram of an ion scheduling method using an ion scheduling device and a quadrupole.

There are multiple technologies that may be used to achieve this “ion scheduling” process. Typical methods involve separating ions under the exposure of two different forces, such as DC potential, RF pseudopotential (or travelling wave), or collisional drag with buffer gas. A method of ion scheduling comprising parallel acquisition of ions followed by serial fragmentation is discloses in U.S. Pat. No. 10,665,441. A parallel accumulation and serial fragmentation method from a trapped ion mobility spectrometry (TIMS) device is also disclosed in Meier, F. et al. Parallel Accumulation-Serial Fragmentation (PASEF): Multiplying Sequencing Speed and Sensitivity by Synchronized Scans in a Trapped Ion Mobility Device. Journal of Proteome Research 2015, 12, 5378-5387, U.S. Pat. Nos. 9,891,194 and 10,794,861). Other implementations include accumulation into multiple traps, either orthogonally across an RF pseudopotential (U.S. Pat. No. 10,199,208) or via ion mobility (U.S. Pat. No. 9,607,817).

It is also known to utilise travelling waves to propel ions through ion guides. U.S. Pat. No. 7,375,344 discloses the application of a series of out-of-phase RF potentials, while Giles et al, Applications of a travelling wave-based radio-frequency-only stacked ring ion guide, Rapid Commun. Mass Spectrom. 2004; 18:2401-2414, discloses the application of switched DC pulses to successive axial segments of an ion guide to create a potential front that moves down the centre of the guide with time, dragging ions with it.

Mass spectrometers control ion loading to trapping devices by varying ion accumulation time, in a process known as Automatic Gain Control (AGC). Ion scheduling devices necessarily block this process by transforming a continuous ion beam into time-varying, concentrated pulses of ions of similar m/z. It is believed that this issue may be resolved by a downstream beam attenuating device, most promisingly by varying the duty cycle of a rapidly pulsed ion optical gating element. U.S. Pat. No. 7,960,690 has demonstrated this effect with 1 kHz switching, where ion packets are expected to emerge with <2 ms pulse width.

Tandem mass spectrometry methods involve the isolation and fragmentation of eluted analyte species, whereby fragment mass spectra are then generated and mass analysed to return structural and quantitative information. These MS/MS, or MS2 spectra are often supported by survey analyses of a wide range of unfragmented precursor ions, termed MS1, MS or Full-MS analyses, that provide information on their accurate m/z and intensity. For Data Independent Acquisition (DIA) methods, this analysis is optional, but for Data Dependent Acquisition (DDA), it is required to generate a list of precursor targets for MS2 analysis. A substantial problem is posed by the dynamic range of the MS1 spectrum. Digested peptide concentration varies by up to 10 orders of magnitude, but the dynamic range of a single shot spectrum in, for example, an orbital trapping mass analyser is limited to 4. Furthermore, the number of ions that may be injected into an orbital trapping mass analyser is limited by the capacity of the accumulating C-Trap to ~10⁵, and consequently low intensity peptide precursor signals are easily overwhelmed and potential targets for fragmentation missed or poorly quantified.

One important method to improve the dynamic range of the MS1 spectrum is the High Dynamic Range (HDR), or Boxcar method, whereby the wide m/z range of interest for the analysis is subdivided into a number of narrower isolation windows, and a separate injection made into the C-Trap for each, with differing fill time dependent on the ion current (Meier et al, Nature Methods, 2018, 15, 440-448). The total ion population is then analysed together, for example in an orbital trapping mass analyser. By this method heavily populated regions are attenuated and sparsely populated mass regions amplified, boosting many relatively weak peaks and greatly improving the effective dynamic range of the scan. This comes at the cost of greatly increasing the time required to accumulate ions over multiple fills. Because of the long fill times for low-level windows, and the milliseconds required to switch the quadrupole and ion source voltages, HDR analyses quickly impacts the rate at which MS2 scans that may be made.

Against this background, the present disclosure provides an improved, or at least commercially relevant alternative method of scheduling ions for analysis is provided.

### SUMMARY

According to a first aspect, a method of scheduling ions for analysis over a mass to charge (m/z) range of interest is provided. The method comprises:
obtaining a list of ion intensities and associated m/z for the ions to be analysed;
obtaining a plurality of target m/z or plurality of target m/z ranges to be analysed;
assigning each target m/z or target m/z range to a first group or a second group based on the list of ion intensities and associated m/z of the ions and an intensity threshold, wherein the target m/z or target m/z ranges in the first group are associated with higher intensity ions than the target m/z or target m/z ranges in the second group;
using an ion selection device to sequentially select and output ions having target m/z or target m/z ranges assigned to the first group for analysis; and
using the ion selection device to sequentially select and output ions having target m/z or target m/z ranges assigned to the second group for analysis.

The interaction of ion scheduling with fast (200-400 Hz) spectral acquisition, fast switching between MS1 and MS2 analyses, and control of the ion population of space charge limited downstream trapping regions (e.g. via automatic gain control) has emerged as considerable technological challenge. The method of the first aspect provides a method for scheduling ions for analysis (e.g. mass spectrometry analysis or ion mobility analysis) which provides for improved control of the ion population in order to improve the dynamic range of mass analyses performed using the scheduled ions.

In order to schedule ions for analysis, the method of the first aspect obtains a list of targets to be analysed. The list of targets may comprise target m/z corresponding to specific ion species (e.g. specific precursor ions for a DDA methodology) or target m/z ranges (e.g. for a DIA methodology).

The method of the first aspect also obtains a list of ion intensities and associated m/z for the ions to be analysed. The list of ion intensities may be obtained using a prior survey analysis performed by a mass spectrometry system, or may be a prediction of the expected ions, e.g. based on an earlier experiment or a preceding measurement cycle of the mass spectrometry system. The method of the first aspect utilises the knowledge of the ion intensities and associated m/z to group targets (target m/z or target m/z ranges) of similar intensity together. Once grouped, the targets are scheduled for analysis sequentially (e.g. in order of m/z or ion mobility, or any other specified order). The sequential separation of the target ions is performed by an ion selection device, which in some embodiments may comprise an ion scheduling device.

By grouping analyses together based on the intensity of the target m/z ions (or the expected intensity of ions within each target m/z range), the dynamic range of the subsequent analyses may be improved.

Furthermore, by outputting ions sequentially within each group of targets, the overall speed of outputting the targets may be improved by reducing the time to stabilise the ion selection device between sequential outputs.

In some embodiments, the ion selection device may have an associated fill time for receiving ions, wherein a fill time for selecting and outputting ions for the second group of target m/z or target m/z ranges is longer than a fill time for selecting and outputting ions for the first group of target m/z or target m/z ranges. Thus, by analysing the relatively high intensity targets in a first group, the fill times for the first group may be relatively short. This may then allow for additional time to be spent acquiring ions for targets of the second group (i.e. a longer fill time), where the ions are less intense. As such, ions falling within the second group of targets may be acquired with improved dynamic range.

While the method of the first aspect encompasses dividing the target m/z or target m/z ranges between two groups, it will be appreciated that in some embodiments three or more groups of target m/z or target m/z ranges may be provided, each group having an associated ion intensity range. Each target m/z value or target m/z range may be assigned to one of the three or more groups based on the list of ion intensities and associated m/z of the ions. As such, target m/z or target m/z ranges may be grouped together with other targets having similar intensities. The fill time associated with each group of targets may be adjusted based on the intensities of the ions within the group.

The number of targets within each group may be selected in accordance with the type of experiment being performed. The number of targets within each group may also depend on the properties of the ion selection device and the distribution and intensity of the ion population to be analysed. For example, in some embodiments, the number of targets within the first group (the most intense ions) may depend on the number of relatively intense ion species present. In some embodiments, there may be no more than: 20, 15, or 10 targets within the first group. Subsequent groups may have a similar number of targets, or the second group (and the third group and so on) may have a greater number of targets within each group, e.g. about 50 targets.

In some embodiments, the ion selection device may sequentially select and output ions having target m/z or target m/z ranges assigned to the first group for analysis before selecting and outputting ions assigned to the second group of ions. As such, in some embodiments, the most intense ion species may be scheduled for analysis first, followed by lower intensity ions.

In some embodiments, the ion selection device may sequentially select and output ions having target m/z or target m/z ranges assigned to the second group for analysis before the selecting and outputting ions assigned to the first group. As such, in some embodiments, relatively lower intensity ion species may be scheduled for analysis first. By prioritising lower intensity species, the method of ion scheduling may improve the detection of lower intensity species, compared to methodologies which analyse ion species in order of intensity.

In some embodiments where ions are assigned to three or more groups, the groups of ions may be analysed in any order. In particular, the groups may be analysed in order of ascending or descending intensity.

In some embodiments, the ion selection device may select and output ions assigned to each group in a respective ion selection cycle. As such, in first ion selection cycle, the ion selection device may be filled with ions and then select and output ions having target m/z values or target m/z ranges assigned to the first group (or the second group). In a second ion selection cycle, the ion selection device may be filled with ions and then select and output ions having target m/z values or target m/z ranges assigned to the next group, and so on. Where ions are assigned to three or more groups, an associated number of ion selection cycles may be performed.

In some embodiments, the ion selection device may comprise an ion scheduling device configured to separate the ions into a plurality of packets of ions based on the m/z or ion mobility of the ions, and to output the packets of ions sequentially in order of their m/z or ion mobility. According to this disclosure, an ion scheduling device is understood to be a device which separates a quantity of ions to into packets of ions which are separated sequentially according to the m/z or ion mobility of the ions. Where the ion selection device comprises an ion scheduling device, an ion selection cycle may correspond to a cycle of the ion scheduling device (i.e. a fill and subsequent emptying of the ion scheduling device).

In some embodiments, the ion selection device may further comprise a mass filtering device configured to receive each packet of ions. For each packet of ions, the mass filtering device may select a subset of the ions based on the plurality of target m/z values or plurality of target m/z ranges. As such, the subset of ions output by the mass filtering device may correspond to the target m/z or target m/z range to be scheduled for analysis. Thus, an ion scheduling device and a mass filtering device may operate in conjunction to schedule ions having different target m/z or target m/z ranges for analysis in a sequential order which improves the dynamic range of the ions to be analysed.

In some embodiments, for each target m/z or target m/z range of the first group, ions may be transferred to the mass filtering device without undergoing separation in the ion scheduling device. A subset of ions having each target m/z or target m/z range may be selected using the mass filtering device. As such, for relatively intense ions which require limited fill times, it may be preferable to not separate the ions using an ion separation device. Rather the intense ions may be selected (filtered) directly by the mass filtering device. Ions having a lower intensity forming part of the second group (or a third group and so on) may still be subject to separation using the ion scheduling device in order to separate the lower intensity ions from the higher intensity ions targeted in the first group.

In some embodiments, the ion scheduling device may perform a plurality of ion scheduling cycles. For example, each ion scheduling cycle may comprise the ion scheduling device receiving ions, wherein the ion scheduling device separates the ions into a plurality of packets of ions according to their m/z or ion mobility and outputs the plurality of groups sequentially. Ions having target m/z or target m/z ranges assigned to the first group may be output during one or more first ion scheduling cycles. Ions having target m/z or target m/z ranges assigned to the second group may be output during one or more second ion scheduling cycles. Where the target m/z or target m/z ranges are assigned to three or more groups, three more sets of ion scheduling cycles may be performed accordingly. By scheduling ions for analysis over a plurality of ion scheduling cycles, targets of a similar intensity may be scheduled for analysis in the same ion scheduling cycle, thereby improving the dynamic range of the ions output for analysis.

In some embodiments, each packet of ions output by the ion scheduling device may have an associated m/z range or ion mobility range, wherein where two or more target m/z or target m/z ranges of the first group fall within a m/z range or ion mobility range of a packet of ions, a plurality of first ion scheduling cycles are performed such that no more than one subset of ions is selected from each packet of ions. Where a plurality of first ion scheduling cycles are to be performed (or a plurality of ion scheduling cycles for any other group), the target m/z values or target m/z ranges may be scheduled in order of intensity, with the most intense targets being scheduled first. Thus, within the first group, the initial first ion scheduling cycle may select ions of a relatively higher intensity compared to subsequent first ion scheduling cycles. A fill time for each first ion scheduling cycle may adjusted to reflect the different intensity of the target ions in each first ion scheduling cycle. Similarly, the fill times for each second ion scheduling cycle may be adjusted and so on.

In some embodiments where a plurality of ion scheduling cycles are performed (e.g. a plurality of first ion scheduling cycles, or any other group of ion scheduling cycles), a fill time of the ion scheduling device may be adjusted for each ion scheduling cycle. For example, the fill time may be adjusted based on the average intensity of the ions for the target m/z or target m/z ranges to be selected in the ion scheduling cycle. Ion scheduling cycles may be repeated until all target m/z or target m/z ranges from a group are completed.

In some embodiments, target m/z or target m/z ranges may be promoted from the second group to the first group in order to increase the utilisation of packets of ions output by the ion scheduling device. Similarly, where three or more groups are used, target m/z or target m/z ranges may be promoted from one group to another group associated with a higher ion intensity range (e.g. a target m/z may be promoted from a fourth group to third group having a higher ion intensity range). Accordingly, ions may be scheduled for analysis in a manner which makes efficient use of the packets output by the ion scheduling device.

In some embodiments, target m/z values or target m/z ranges may be demoted from the first group to the second group in order to increase the utilisation of packets of ions output by the ion scheduling device. Similarly, where three or more groups are used, target m/z or target m/z ranges may be demoted from one group to another group associated with a lower ion intensity range (e.g. a target m/z value may be demoted from a second group to a third group having a lower ion intensity range). By demoting ions, particularly ions assigned to a first group (i.e. the most intense ion species), the first group may comprise a limited number of relatively high intensity ion species. Accordingly, a fill time of the ion scheduling device for e.g. the first group of ions may be reduced in order reduce the cycle time for the ion scheduling device.

In some embodiments, the ion scheduling device may output a packet of ions having a m/z range or ion mobility range for which there is no target m/z or target m/z range. In such cases, the ions may be discarded. The packet of ions may still be utilised by the mass spectrometry system if there is some further use for the ions. For example, “spare” packets of ions in a group may be used for measurement of unfragmented precursors, used for an additional MS2 measurement, or even a separate full-MS measurement taken from a bypass, so as not to waste ions or time.

In some embodiments, the assignment of target m/z or target m/z ranges to the first and second groups may be optimised to reduce the occurrence of ion scheduling cycles where a packet of ions is output without having an associated target m/z or target m/z range. For example, a target m/z or target m/z range may be promoted up a group in order to utilise an available ion packet in an earlier ion scheduling cycle. The promotion of a target m/z or target m/z range may be subject to a maximum intensity difference in order to avoid the promotion substantially affecting the dynamic range of the ions having the promoted target m/z or target m/z range.

In some embodiments, the method of the first aspect may be provided as part of a Data Independent Acquisition (DIA) method of mass spectrometry. For the DIA method, the m/z range of interest is divided into a plurality of target m/z ranges (i.e. DIA windows) to be analysed. Typically each DIA window may be no greater than 20 Th, 10 Th, 5 Th, 3 Th or 2 Th wide. For the ions of each target m/z range output by the ion selection device, the DIA method further comprises fragmenting the ions of each target m/z range and mass analysing the ions. By incorporating the method of ion scheduling of the first aspect into a DIA mass spectrometry method, the ions output within each DIA window may have improved dynamic range.

In some embodiments, the method of the first aspect may be provided as part of a Data Dependent Acquisition (DDA) method of mass spectrometry. For the DDA method, a plurality of target m/z of interest may be obtained. For example, the target m/z values of interest may be identified from the most intense species in the obtained list of m/z and associated intensities. Target m/z may be assigned to two or more groups based on the intensities, which may then be output by the ion selection device. The DDA method may further comprise fragmenting the ions of each target m/z range and mass analysing the fragment ions. By incorporating the method of ion scheduling of the first aspect into a DDA mass spectrometry method, the target ions output for DDA analysis window may have improved dynamic range.

In some embodiments, the ion selection device may comprise a first ion scheduling device and a second ion scheduling device. The first ion scheduling device may be configured to separate the ions into a plurality of first packets of ions based on the m/z or ion mobility of the ions, and to output the first packets of ions sequentially in order of their m/z or ion mobility to the second ion scheduling device. The second ion scheduling device may be configured to separate each packet of ions into plurality of second packets of ions based on the m/z or ion mobility of the ions, and to output the second packets of ions sequentially in order of their m/z or ion mobility. In some embodiments, the first ion scheduling device may have a larger ion capacity than the second ion scheduling device. Thus, the first ion scheduling device may accumulate a relatively large quantity of ions, and then release them in rough order of m/z. The second ion scheduling device may then subdivide these narrower m/z ranges into more finely resolved packets of ions in the manner as discussed above. The fill time of the second ion scheduling device may be controlled for each m/z range of ion received from the first ion scheduling device in order to improve the dynamic range of ions scheduled.

In some embodiments, the fill time of the second ion scheduling device may be adjusted for each first packet of ions received based on the list of ion intensities and associated m/z for the ions to be analysed. Thus, the dynamic range of the ions scheduled for analysis may be improved.

In some embodiments, for the second group of ions, a pre-filter, or mass filtering device, provided upstream of the ion selection device may selectively attenuate the ions provided to the ion selection device based on the target m/z or target m/z ranges of the first group. For example, the pre-filter may act as a notch filter, or bandpass filter. That is, the pre-filter may selectively remove ions of a m/z or m/z range based on the targets assigned to the first group. Thus, the ions to be separated as part of the second group may have a further improved dynamic range, as the ions from the first group may be filtered out prior to entering the ion selection device.

In some embodiments, the ion scheduling device may comprise a linear ion guide within which ions are separated. In other embodiments, the ion scheduling device may comprise a plurality of ion traps (a multi-trap ion scheduling device). Each ion trap may have an associated m/z acceptance window or an associated ion mobility acceptance window. In some embodiments, the plurality of ion traps may output packets of ions in sequence such that the ion scheduling device outputs the packets of ions according to the m/z or ion mobility of the ions. As such, the multi-trap ion scheduling device may accumulate ions in each ion trap in parallel and then the packets of ions may then be output sequentially from the ion traps. In some embodiments, for one or more target m/z or target m/z ranges, the ion scheduling device may output ions from two or more ion traps simultaneously to form a packet of ions.

In some embodiments, the method of the first aspect may be provided as part of a High Dynamic Range (HDR) method of mass spectrometry. In such embodiments, the HDR method may further comprise:
accumulating ions associated with one or more target m/z or target m/z ranges of the first group output by the ion selection device in an ion trap; and
mass analysing the accumulated ions in the MS1 domain to produce one or mass spectra of ions assigned to the first group;
accumulating ions associated with one or more target m/z or target m/z ranges of the second group output by the ion selection device in an ion trap; and
mass analysing the accumulated ions in the MS1 domain to produce one or mass spectra of ions assigned to the second group; and
assembling a HDR mass spectrum from the mass spectra of ions assigned to the first and second groups. By incorporating the method of ion scheduling of the first aspect into a HDR mass spectrometry method, the time taken to accumulate ions for a HDR method may be significantly reduced. This in turn may allow HDR analyses to be more readily incorporated into DDA or DIA workflows.

In some embodiments, no more than: 10, 7, 5, or 3 target m/z or target m/z ranges are assigned to the first group. By limiting the number of targets in the first group, some ion packets output by the ion scheduling device may be skipped (i.e. one or more packets may have no associated target). This in turn may allow the fill time for the first ion scheduling cycle to be minimised, allowing the first ion scheduling cycle to be completed quickly. This in turn may improve the overall cycle speed of the method or provide increased time for subsequent groups to accumulate ions.

In some embodiments, the ions to be scheduled for analysis may be scheduled for different types of analysis (e.g. MS1, MS2, MS3, or MSⁿ). In embodiments where there are e.g. MS3 analyses to be performed, the AGC target for the MS3 analyses may be significantly higher than the AGC target for e.g. MS1 or MS2 analyses to allow for sufficient surviving ions after the second stage of fragmentation. Thus, in some embodiments the assignment of targets to groups my reassign targets to account for this. As such, in some embodiments the step of obtaining a plurality of target m/z or plurality of target m/z ranges to be analysed may comprise obtaining a target ion current for one or more the target m/z or target m/z ranges. Then, when assigning each target m/z or target m/z range to a first group or a second group be based on the list of ion intensities and associated m/z of the ions and the intensity threshold, the target ion current may also be considered. A target m/z or target m/z range assigned to the first group may be reassigned to the second group based on the target ion current of the target m/z or target m/z range for example.

While in some embodiments the ion selection device may comprise an ion scheduling device, it will be appreciated that the method of the first aspect is not limited to ions scheduling methodologies. As such, in some embodiments the ion selection device may be a mass filtering device which filters the ions and outputs a subset of ions based on having a target m/z or target m/z range for each of the target m/z values or target m/z ranges in the first and second groups.

According to a second aspect of the disclosure, a mass spectrometry system for analysing ions over a m/z range of interest is provided. The mass spectrometry system comprising an ion selection device, and a mass analyser. The mass spectrometry system is configured to perform the method of the first aspect.

As such, the mass spectrometry system of the second aspect may be used to perform a method of scheduling ions in accordance with the first aspect of the disclosure. As such, it will be appreciated that the mass spectrometry system of the second aspect may incorporate any of the optional features and associated advantages of the first aspect. In some embodiments, the mass spectrometry system may comprise a controller which is configured to cause the mass spectrometry system to perform the method of the first aspect.

According to a third aspect of the disclosure, a computer program comprising instructions to cause a mass spectrometry system of the second aspect to execute the steps of the method of the first aspect is provided. As such, it will be appreciated that the computer program of the third aspect may incorporate any of the optional features, and associated advantages, of the first or second aspects discussed above.

According to a fourth aspect of the disclosure, a computer-readable medium having stored thereon the computer program of the third aspect is provided. As such, it will be appreciated that the computer-readable medium of the fourth aspect may incorporate any of the optional features, and associated advantages, of the first, second, or third aspects discussed above.

### BRIEF DESCRIPTION OF THE FIGURES

Embodiments of the disclosure will now be described with reference to the following non-limiting figures in which:

FIG. 1 is a schematic diagram showing the separation of different m/z ions along an ion guide by opposing an axial pseudopotential (T-wave) force with a variable DC force;

FIG. 2 is a schematic diagram of an ion scheduling method, whereby ions of three different m/z values are accumulated and released in line with resolving quadrupole isolation window;

FIG. 3A shows a schematic diagram of an ion scheduling device according to this disclosure including a single ion trap ion scheduling device;

FIG. 3B shows a schematic diagram of an ion scheduling device according to this disclosure comprising a bypass;

FIG. 3C shows a schematic diagram of a multi-ion trap ion scheduling device according to this disclosure;

FIG. 4 is a schematic diagram of a mass spectrometry system comprising an ion scheduling device according to an embodiment of the disclosure;

FIG. 5 shows a flowchart of a method according to an embodiment of the disclosure;

FIG. 6 shows a mass spectrum comprising m/z peaks assigned to different groups;

FIG. 7 shows a schematic diagram of an ion scheduling device and an attenuating ion gate;

FIG. 8A is a graph showing an order of analyses for an ion scheduling method;

FIG. 8B is a graph showing the deviation in m/z of the m/z range for the ion packets of the ion scheduling device for each ion-scheduling cycle for the analyses shown in FIG. 8A;

FIG. 9 is a flowchart of a further method according to an embodiment of the disclosure;

FIG. 10A a graph resulting from sorting of 42 DIA windows (10 Th, overall cycle 350-760), with a random intensity distribution, into optimized groups based on intensity and sufficient m/z dispersion for ions in the same cycle >50 Th).

FIG. 10B shows a graph of m/z target vs analysis number for the groups of FIG. 10A; and

FIG. 11 shows a schematic diagram of a pre-filter placed upstream of the ion scheduling device to limit the incoming mass range and remove excess ions.

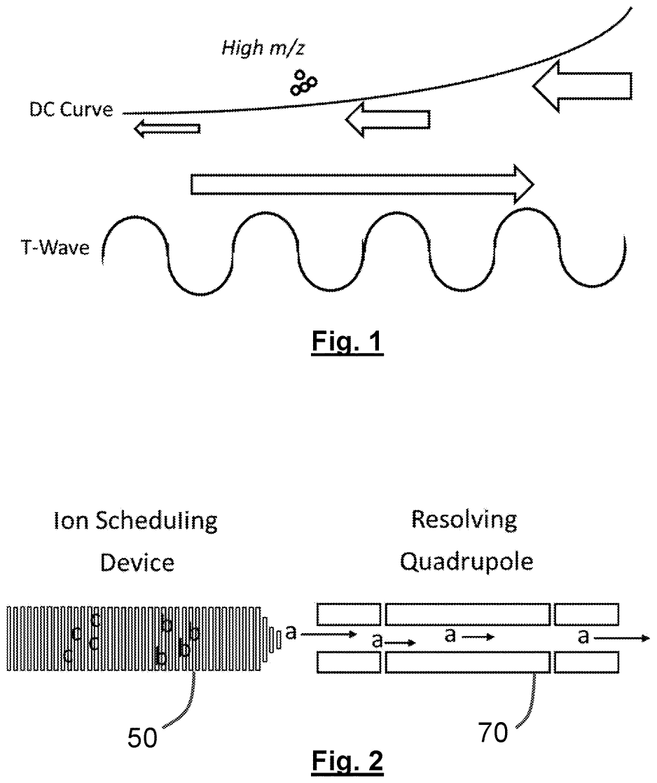

### DETAILED DESCRIPTION

Throughout this disclosure, the term “intensity”, when used in reference to a collection of ions, refers to a quantity of, or a flux of, ions of a particular type that are generated from a common sample and that are detected by a mass spectrometer operated under controlled conditions (e.g., without limitation, during a certain common measurement time period). In practical terms, the ion intensity is the magnitude of a signal that corresponds to the quantity of or flux of ions of the particular ion type that are/is detected. In many instances, the phrase “particular type”, as used above, may refer to ions comprising a particular mass-to-charge (m/z) ratio or a particular restricted range of m/z ratios. In many instances, the measured m/z ratio may be correlated with or indicative of the presence of a particular ion composition (i.e., an ion species).

According to an embodiment of the disclosure, a spectrometry system is provided. For example, FIG. 4 shows a schematic diagram of a spectrometry system, which is a mass spectrometry system 1, according to an embodiment of the disclosure. A method of scheduling ions (ion scheduling) according to an embodiment of this disclosure may be performed by the mass spectrometry system 1. In other embodiments, the spectrometry system may comprise an ion mobility analyser (an ion mobility spectrometry system).

The mass spectrometry system 1 may be used to analyse a sample supplied from a chromatographic apparatus such as a liquid chromatography (LC) column (not shown in FIG. 4). One such example of an LC column is the Thermo Fisher Scientific, Inc ProSwift (RTM) monolithic column which offers high performance liquid chromatography (HPLC) through the forcing of the sample carried in a mobile phase under high pressure through a stationary phase of irregularly or spherically shaped particles constituting the stationary phase. In the HPLC column, sample molecules elute at different rates according to their degree of interaction with the stationary phase. In other embodiments, sample molecules may be supplied by any other suitable means, for example a gas chromatography column or other sample delivery methods known to the skilled person.

The sample molecules may be ionized using an ion source to generate precursor ions. In the embodiment of FIG. 4, the ion source is an electrospray ionization source (ESI source) 20 which is at atmospheric pressure.

Precursor ions generated by the ESI source 20 may then enter a vacuum chamber of the mass spectrometry system 1 and are directed by a capillary 25 into an ion funnel 30. The precursor ions are focused by the ion funnel 30 into an inject filter 40 which injects the precursor ions into an ion scheduling device 50. In some embodiments, this may operate as a mass filter in order to selectively attenuate the ions.

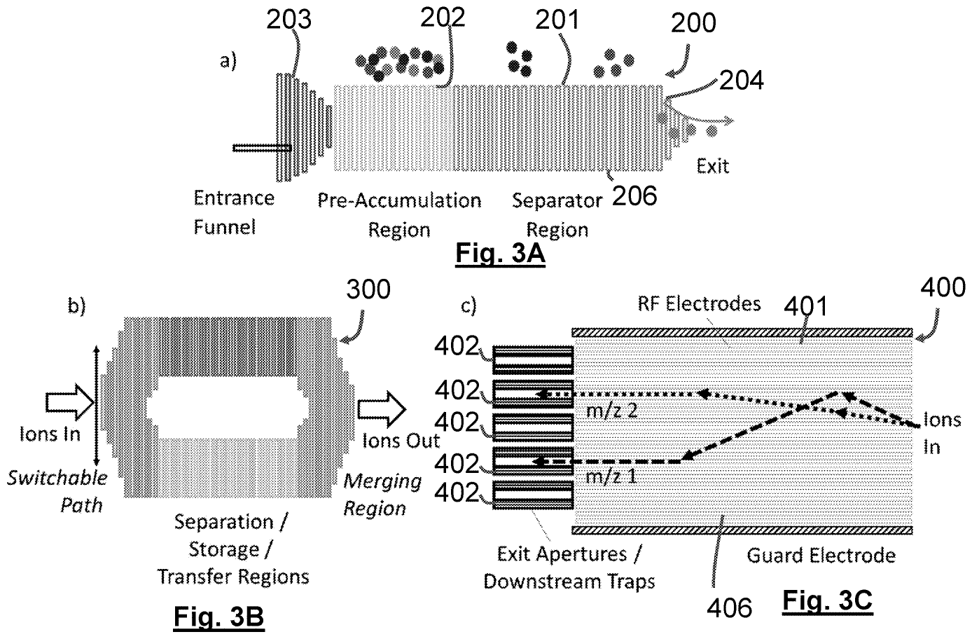

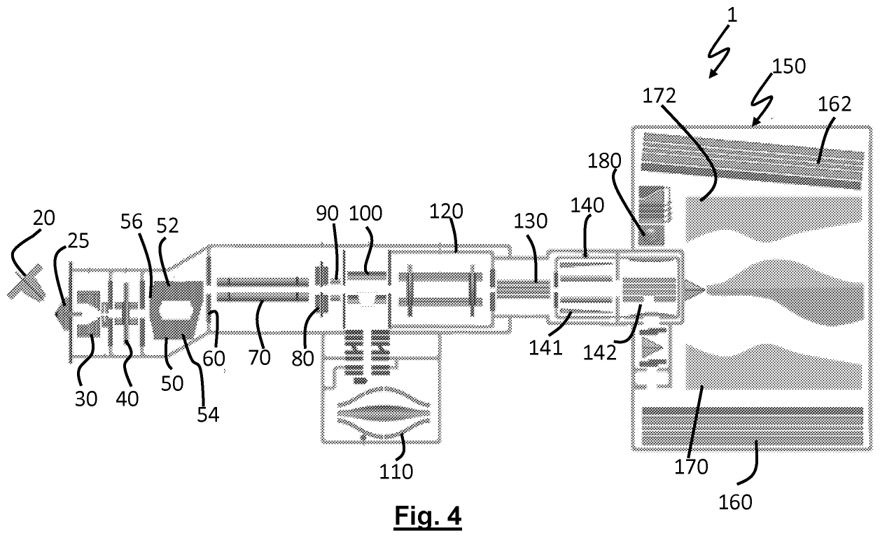

The ion scheduling device 50 shown in FIG. 4 comprises an ion separation path 52 along which ions are separated according to their m/z, and a bypass path 54 along which ions are not separated according to their m/z. The ion scheduling device also comprises a path selection region 56 which selects whether ions travel along the ion separation path 52 or the bypass path 54. As such, the ion scheduling device 50 shown in FIG. 4 is an ion scheduling device comprising a bypass, for example as further shown in FIG. 3B). It will be appreciated that the ion scheduling devices of FIGS. 3A) and 3C) may also be used as the ion scheduling device 50 for the mass spectrometry system 1 as further described below. Further details of ion scheduling devices 50 according to this disclosure are discussed in more detail below.

An ion attenuation device 60 may be located at the distal end of the ion scheduling device 50. The ion attenuation device 60 may be configured to control the passage of the precursor ions from the ion scheduling device 50 into a downstream mass selector in the form of a quadrupole mass filter 70. Alternatively, the ion attenuating device 60 may be replaced by a static lens (not shown in FIG. 4) which may be configured to direct ions from the ion scheduling device 50 to the quadrupole mass filter 70 without any intentional attenuation of the ions. The ion attenuation device 60 in some embodiments may also be located after (i.e. downstream of) the quadrupole mass filter 70.

The quadrupole mass filter 70 is typically, but not necessarily, segmented and serves as a band pass filter, allowing passage of a selected m/z or limited m/z range whilst excluding precursor ions of other m/z. As such, the quadrupole mass filter 70 may be an ion selection device according to this disclosure. That is, the quadrupole mass filter 70 may be configured to select a subset of ions from a quantity of ions received by the quadrupole mass filter 70. In some embodiments, the quadrupole mass filter 70 may be operated to sequentially select and output ions in order of their m/z (e.g. increasing m/z or decreasing m/z). For example, the quadrupole mass filter 70 may gradually shift a pass band, or m/z window, of the quadrupole mass filter 70 in order to change the m/z of the ions output by the quadrupole mass filter 70. The quadrupole mass filter 70 may also be operated in an RF-only mode in which it is not m/z selective, i.e. it transmits substantially all m/z precursor ions.

Although a quadrupole mass filter 70 is shown in FIG. 4, it will be appreciated that any suitable ion selection device which may filter ions on the basis of their m/z or ion mobility may be used as an ion selection device. In the embodiment of FIG. 4, the quadrupole mass filter 70 is downstream of the ion scheduling device 50. In some embodiments, the quadrupole mass filter 70 may be used in conjunction with the ion scheduling device 50 to form an ion selection device.

Furthermore, in some embodiments, more than one ion selection device 50 may be provided. For example, a further mass selection device may be provided downstream of an ion routing multipole 120. In this way, MS³ or MSⁿ scans can be performed if desired (typically using the time of flight (TOF) mass analyser 150 for mass analysis).

The mass spectrometry system 1 may be operated in various modes of operation in order to perform analysis of the precursor ions in the MS1 domain and/or the MS2 domain. In a first mode of operation, the precursor ions may be analysed in the MS1 domain using a first mass analyser (for example, the orbital trapping mass analyser 110 of FIG. 4). As such, according to this disclosure, in a first mode of operation of the mass spectrometry system 1 an MS1 analysis may be performed using the orbital trapping mass analyser 110.

In the first mode of operation, precursor ions may exit the quadrupole mass filter 70 through an ion gate 80 and a transfer multipole 90 into a first ion trap 100 (curved trap, or C-trap). The first ion trap 100 has longitudinally extending electrodes which are supplied with RF voltages and end caps that to which DC voltages are supplied. The result is a potential well that extends along the longitudinal axis of the first ion trap 100.

In a first mode of operation, ions may be captured and cooled in the first ion trap 100 or transferred to on to the ion routing multipole 120, where the ions are cooled in the ion routing multipole 120. The movement of the ions may be controlled by DC end cap voltages applied to the first ion trap 100. The injection time (IT) of the ions into the first ion trap 100 (or the ion routing multipole 120) determines the number of precursor ions (ion population) that is available for subsequent analysis. From the first ion trap 100, or from the ion routing multipole 120, precursor ions may be directed to different parts of the mass spectrometry system 1, depending on the analysis to be performed.

Where precursor ions are to be analysed by the orbital trapping mass analyser 110, if ions are cooled in the ion routing multiple 120, the ions may subsequently be transferred back to the first ion trap 100 for analysis by the Orbital trapping mass analyser 110. The precursor ions may then be ejected orthogonally from the first ion trap 100 towards the orbital trapping mass analyser 110. As shown in FIG. 4, the orbital trapping mass analyser 110 may be an Orbitrap™ mass analyser sold by Thermo Fisher Scientific, Inc. The orbital trapping mass analyser 110 has an off-centre injection aperture and the precursor ions are injected into the orbital trapping mass analyser 110 as coherent packets, through the off-centre injection aperture. Precursor ions are then trapped within the orbital trapping mass analyser 110 by a hyperlogarithmic electric field and undergo back and forth motion in a longitudinal direction whilst orbiting around the inner electrode.

The axial component of the movement of the ion packets in the orbital trapping mass analyser 110 is (more or less) defined as simple harmonic motion, with the angular frequency in the z direction being related to the square root of the mass to charge ratio of a given ion species. Thus, over time, precursor ions separate in accordance with their mass to charge ratio.

Precursor ions in the orbital trapping mass analyser 110 are detected by use of an image current detector (not shown) which produces a “transient” in the time domain containing information on all of the ion species as they pass the image current detector. The transient is then subjected to a Fast Fourier Transform (FFT) resulting in a series of peaks in the frequency domain. From these peaks, a mass spectrum, representing abundance/ion intensity versus m/z, can be produced.

In the configuration described above, the precursor ions within the mass range of interest (selected by the quadrupole mass filter 70) are analysed by the orbital trapping mass analyser 110 without fragmentation. The resulting mass spectrum is denoted MS1.

Although an orbital trapping mass analyser 110 is shown in FIG. 4, it will be appreciated that other mass analysers may be employed as the first mass analyser according to embodiments of this disclosure. For example, a Fourier Transform Ion Cyclotron Resonance (FTICR) mass analyser may be utilised to analyse the precursor ions in the MS1 domain. Mass analysers, such as the orbital trapping mass analyser 110 and Ion Cyclotron Resonance mass analyser, may also be used in the invention even where types of signal processing other than Fourier transformation are used to obtain mass spectral information from the transient signal (see for example WO-A-2013/171313, Thermo Fisher Scientific). In some embodiments, a TOF mass analyser may also be used in place of the orbital trapping mass analyser 110 to analyse the precursor ions in the MS1 domain.

In a second mode of operation of the mass spectrometry system 1, precursor ions may be analysed by the TOF mass analyser 150 (second mass analyser) in the MS1 domain (an MS1 scan performed by TOF mass analyser 150). The precursor ions to be analysed by the second mass analyser may be mass filtered by the quadrupole mass filter 70. As such, the precursor ions may be filtered to include precursor ions from the m/z range of interest, or from a m/z subrange of interest.

In order for the TOF mass analyser 150 to analyse precursor ions, precursor ions may pass from the quadrupole exit lens/split lens arrangement 80 and first transfer multipole 90 into the first ion trap 100 and continue their path through the first ion trap 100 and into the ion routing multipole 120. As such, the first ion trap 100 may effectively be operated as an ion guide in the second mode of operation. Alternatively, the precursor ions may be cooled in the first ion trap 100 and may be subsequently ejected from the first ion trap 100 in an axial direction into the ion routing multipole 120. The precursor ions may then continue through the ion routing multipole 120 and be ejected from the ion routing multipole 120 at the opposing axial end to the first ion trap 100. As such, the ion routing multipole 120 may also effectively be operated as an ion guide in the second mode of operation.

The ejected precursor ions pass into an ion guide 130. The ion guide 130 may be configured to guide the precursor ions from the ion routing multipole 120 into an ion processor 140. The ion processor 140 may be configured to process ions into an ion packet suitable for injection into the TOF mass analyser 150. The ion processor 140 may comprise an RF voltage-controlled third ion trap containing a buffer gas. For example, a suitable buffer gas is nitrogen at a pressure in the range 5×10⁻⁴ mbar to 2×10⁻² mbar. The ion processor may optionally be used to induce fragmentation of the ions for analysis in the MS2 domain. For analysis in the MS1 domain, fragmentation of the ions is not intended, so ions may be transferred from the fragmentation chamber 141 of the ion processor to the extraction trap 142 of the ion processor without undergoing any intentional fragmentation. The ion processor 140 has the ability to quickly switch off the applied RF voltage and apply a DC voltage to extract the trapped precursor ions. A suitable flat plate extraction trap, also referred to as a rectilinear ion trap, is further described in U.S. Pat. No. 9,548,195 (B2).

Although an ion processor 140 (ion trap) is shown in the embodiment of FIG. 4, it will be appreciated that other methods of forming an ion packet of precursor ions may also be provided. For example, relatively slow transfer of ions through a multipole can be used to affect bunching of ions, which can subsequently be ejected as a single packet to the TOF mass analyser 150. Alternatively, orthogonal displacement of precursor ions may be used to form an ion packet. Further details of these alternatives are found in US-A-20030001088 which describes a travelling wave ion bunching method, the contents of which are herein incorporated by reference.

In FIG. 4, the TOF mass analyser 150 shown is a multiple reflection time of flight mass analyser (MR-TOF). The TOF mass analyser 150 is constructed around two opposing ion mirrors 160, 162, elongated in a drift direction. The mirrors are opposed in a direction that is orthogonal to the drift direction. The ion processor 140 injects ions into the first mirror 160 and the ions then oscillate between the two mirrors 160, 162. The angle of ejection of ions from the extraction trap 140 and additional deflectors 170, 172 allow control of the energy of the ions in the drift direction, such that ions are directed down the length of the mirrors 160, 162 as they oscillate, producing a zig-zag trajectory. The mirrors 160, 162 themselves are tilted relative to one another, producing a potential gradient that retards the ions'drift velocity and causes them to be reflected back in the drift dimension and focused onto a detector 180.

Precursor ions accumulated in the ion processor 140 are injected into the TOF mass analyser 150 (second mass analyser) as a packet of ions. The time taken for the precursor ions to arrive at the detector 180 is recorded by the TOF mass analyser 150 and used to generate an MS1 mass spectrum of the precursor ions.

In a third mode of operation of the mass spectrometry system 1, the TOF mass analyser 150 (second mass analyser) may be used to analyse the precursor ions in the MS2 domain (a MS2 scan).

In order to analyse the precursor ions in the MS2 domain, some of the precursor ions may be transferred from the quadrupole mass filter 70 to the ion routing multipole 120 in a manner similar to second mode of operation discussed above. The precursor ions to be transferred may be a packet of ions which have been output from the ion scheduling device 50, or a packet of precursor ions which have not been subjected to ion scheduling. The output ions (i.e. the packet of ions) may be further mass selected by the quadrupole mass filter 70. For example, the output ions may be further mass selected to include targeted precursor ion species, or further mass filtered using an m/z isolation window (a target m/z range) of the quadrupole mass filter 70 (e.g. as part of a DIA methodology), as discussed in more detail below.

Ions may then be transferred to the fragmentation chamber 141 of the ion processor 140. The fragmentation chamber 141 is, in the mass spectrometry system 1 of FIG. 4, a higher energy collisional dissociation (HCD) device. A buffer gas may be supplied to the fragmentation chamber 141. When precursor ions are to be fragmented, the kinetic energy of the precursor ions may be increased, so that precursor ions arriving at the fragmentation chamber 141 and colliding with buffer gas molecules results in fragmentation of the precursor ions into fragment ions.

Although a HCD fragmentation chamber 141 is shown in the ion processor 140 of FIG. 4, other fragmentation devices may be employed instead, employing such methods as collision induced dissociation (CID), electron capture dissociation (ECD), electron transfer dissociation (ETD), photodissociation, and so forth.

Fragmented ions may be ejected from the fragmentation chamber 141 into the extraction trap 142 of the ion processor. The ejected fragmented may be accumulated in the extraction trap 142 to form an ion packet. The fragmented ions may then be injected into the TOF mass analyser 150 as described above.

It will be appreciated that in some embodiments, the first mass analyser (orbital trapping mass analyser 110) and the second mass analyser (TOF mass analyser 150) may be operated concurrently. That is to say, the mass spectrometry system 1 may be operated in a first mode of operation concurrently with the second or third mode of operation. According to this disclosure, the ion scheduling device 50 may be operated in order to output groups of ions (and/or subsets of ions from the quadrupole mass filter 70) such that the orbital trapping mass analyser 110 and the TOF mass analyser 150 may be operated in an efficient manner and also with improved dynamic range.

The mass spectrometry system 1 may be under the control of a controller (not shown in FIG. 4) which, for example, is configured to control the timing of ejection of the trapping components, to control one or more power supplies (not shown) to set the appropriate potentials on the electrodes of the quadrupoles etc. so as to focus and filter the ions, to capture the mass spectral data from the orbital trapping device 110, to capture the mass spectral data from the orbital trapping mass analyser 110 and the TOF mass analyser 150, control the sequence of MS1 and MS2 scans and so forth. It will be appreciated that the controller may comprise a computer that may be operated according to a computer program comprising instructions to cause the mass spectrometry system 1 to execute steps in an accordance with the methods described herein.

Next, methods of ion scheduling utilising an ion scheduling device 50 will be described. FIG. 1 is an explanatory diagram which shows one general principle of ion scheduling using a travelling wave. It will be appreciated that the diagram shown in FIG. 1 is only one possible mechanism for ion scheduling using an ion scheduling device 50, and that other methodologies of ion scheduling may also be applied to the methods of this disclosure. In FIG. 1, a non-linear DC potential (an opposing potential gradient) and a travelling wave (a time-varying potential) induce the separation of ions over a length. FIG. 1 shows the travelling wave at a single instance in time; in practice the travelling wave is caused to travel continuously in the first direction (left to right in FIG. 1). The opposing DC and pseudopotential forces cause ions of different m/z to settle at different positions.

To achieve the m/z dependent separation (or ion mobility dependent separation) of FIG. 1, ions may be separated by opposing a potential gradient (e.g. a static field) with a pseudopotential force generated by a dynamic (time-varying) potential. In some ion scheduling devices 50 of the present disclosure, an axial pseudopotential generated by a travelling wave (T-Wave) opposes a rising DC gradient. Such a T-Wave could be a multi-phase (e.g. 3-phase, or higher) travelling wave. The pseudopotential force pushes ions until they reach a region where the DC force is equal to or greater than the pseudopotential force, at which point the ions become trapped (or if the DC gradient is insufficient then the ions are pushed out of the device). As pseudopotential force is dependent on m/z, the trapping position of the ions also depends on their m/z. Hence, ions may be trapped at various different positions in the separation (first) direction.

Separated ions (or separated packets of ions) may be released from the ion scheduling device 50 in an m/z-dependent fashion by scanning/stepping the applied DC potential or the travelling wave amplitude/frequency (or duty cycle/pulse velocity for digital waveforms). Alternatively, many other ways of extracting ions from the guide may be applied: the DC gradient and T-Wave may be removed and ions released over time based on their spatial separation/drift time, or a very slow travelling wave applied to drive out ions in slow bunches, etc. Accumulated ions may then be released, for example to quadrupole mass filter 70 matching their m/z, and the losses at the quadrupole may thus be mitigated.

In particular, it will be appreciated that in some embodiments the ion scheduling device 50 may be configured to separate ions on the basis of ion mobility. As such, the ion scheduling device 50 may separate the ions into a plurality of packets of ions (ion packets), each packet having a different ion mobility range. The ion scheduling device 50 may then output the packets of ions sequentially based on their ion mobility (e.g. packets of ions in order of increasing ion mobility, or groups in order of decreasing ion mobility). For example, the various scheduling devices (or sections thereof) described herein may be configured so as to separate ions on the basis of ion mobility by: (1) discontinuing the generation of travelling-wave voltage AC voltage oscillations (see FIG. 1) and (2) maintaining a constant potential gradient (i.e., a linear variation of DC potential, as opposed to the non-linear variation depicted in the topmost portion of FIG. 1) across the length of the respective device or section while maintaining a controlled gas pressure within the device or section.

Because ions may be separated, one from another, on the basis of ion mobility, it is possible to obtain data from a set of specific target ion species that are targeted for analysis based on their specific respective ion mobilities. Such a method may comprise:
obtaining a list of ion intensities and associated ion mobility values for the ions to be analysed;
obtaining a plurality of target ion mobility ranges to be analysed;
assigning each target ion mobility range to a first group or a second group based on the list of ion intensities, the associated mobility of the ions and an intensity threshold, wherein the target mobility ranges in the first group are associated with higher ion intensity than the target ion mobility range in the second group;
using an ion selection device to sequentially select and output ions having target ion mobility ranges assigned to the first group for analysis;
using the ion selection device to sequentially select and output ions having target ion mobility ranges assigned to the second group for analysis; and
separately mass analysing ions of the first and second outputted groups of accumulated ions.

As the application of a travelling wave potential typically requires axial segmentation of electrodes, the ion scheduling arrangement shown in FIG. 1 may be implemented using a stacked ring ion guide and/or related structures for example. FIG. 3A shows an example of a linear ion scheduling device 200, which is an apparatus for separating ions in which the approach of FIG. 1 may be implemented. The linear ion scheduling device 200 comprises a separator region 201, a pre-accumulation region 202, a funnel/initial capture region 203, and an ion outlet 204.

In this specific example, the linear ion scheduling device 200 has a stacked ring structure, also including optional sections for ion capture from an inlet capillary and a pre-accumulation region 202 to maximise duty cycle. In addition to a separation region 201, in which a T-Wave and DC gradient are applied, the single ion trap ion scheduling device 200 is shown as comprising a similar pre-accumulation region 202 for pre-accumulation of ions whilst the separator 201 is in operation.

The linear ion scheduling device 200 comprises an ion funnel 203 which may receive ions from an inlet capillary, or from an ion gate as shown in FIG. 4, and a small, funnelled region compresses the extracted ions as the ions pass out of the device to a higher vacuum (lower pressure) region. The funnelled 203 and pre-accumulation regions 202 may have their own DC offsets and gradients imposed, and a controllable (i.e. variable) DC barrier may be provided between the accumulator 202 and the separator 201. Potentials (e.g. from auxiliary electrodes, which are not shown) can be applied within the guide to cause the ions to move laterally (i.e. perpendicular to the axis of the ion guide), to permit spreading of high amounts of charge over a wider area to reduce space charge effects.

After the ions have passed through the separation region 201 of the linear ion scheduling device 200, they exit the apparatus through the ion outlet 204, for example to a higher vacuum (lower pressure) ion guide. Hence, in generalised terms, the separation regions and/or accumulation regions described herein may be a vacuum region(s). The separation region 201 and/or accumulation region 202 may be at a lower pressure than an upstream region (i.e. a region that is upstream of the separation region 201 and/or accumulation region 202) of the apparatus and/or may be at a higher pressure than a downstream region (i.e. a region that is downstream of the separation region and/or accumulation region) of the apparatus. Various gas-tight housings and pumping can be provided to ensure a vacuum is formed.

The properties of the travelling wave may preferably be set such that ions pass through the waves, such that the ions feel the influence of a pseudopotential force rather than being completely entrained in the waves. For example, the frequency and/or voltage amplitude of the travelling wave may be varied to achieve this. In principle, a high enough travelling wave potential will just carry ions away and there will be no separation, unless an opposing DC is set high enough to balance this effect. Therefore, the opposing potential and the time-varying potential may be fine-tuned to optimise separation performance.

The linear ion scheduling device 200 may be operated to output ions (or packets of ions) separated according to their m/z. Firstly, ions may be transferred from the injection flatapole 40 to the pre-accumulation region 202 via the ion funnel 203. Ions (e.g. ions of mixed m/z, spanning a m/z range of interest for example) may accumulate in the pre-accumulation region 202. The time (i.e. a fill time) over which ions are allowed to accumulate in the pre-accumulation region 202 may determine the total number of ions which are to be separated in a single ion scheduling cycle. As such, by varying the fill time of the ion scheduling device, the number of ions available to the ion scheduling device may be controlled. The fill time of the ion scheduling device 50 may be controlled in order to improve the dynamic range of the mass spectrometry system, as further discussed below.

The ions may then be transferred from the pre-accumulation region 202 to the separation region 201, which may be achieved via application of either DC gradient/offset across the pre-accumulation region 203 or a travelling wave to push ions along. Once the pre-accumulation region 203 has been emptied of ions, the further transfer of ions from pre-accumulation region 203 to the separation region 201 is blocked (e.g. by activating an ion gate (not shown in FIG. 3A) and the pre-accumulation region 203 begins accumulating further ions as they enter. In parallel to this, the process of separation begins in the separation region 201. The DC gradient (which is preferably curved) amplitude is reduced (or alternatively an increase in travelling wave amplitude is provided, or both) to the level required for the first, lowest, m/z ions to exit. After a short delay (typically on the order of 0.25-5 ms), the first packet of ions are extracted from the separation region 201. The first packet of ions have a m/z falling within a first m/z extraction window, which may be the lowest m/z extraction window of the plurality of m/z extraction windows to be used in the ion scheduling cycle. The controller may select the m/z range for each m/z extraction windows based on the target m/z or target m/z ranges to be output in accordance with the method of ion scheduling.

For example, the mass spectrometry system 1 may be performing an experiment where a m/z range of interest is 300 m/z to 900 m/z. Within this m/z range of interest, each packet of ions output by the ion scheduling device 50 may span a m/z extraction window of about the same size (although in some embodiments the m/z extraction windows may be different sizes). For example, each m/z extraction window width may be at least: 10 Th, 20 Th, 30 Th, 50 Th, 70 Th, 100 Th, 150 Th, or 200 Th. The m/z extraction window width achievable by the ion scheduling device 50 may depend on the resolution of the ion scheduling device 50 and the frequency of operation (i.e. the duration of the ion scheduling cycle) of the ion scheduling device 50. The ions may be separated into m/z dependent (or ion mobility dependent) packets within the separation region 201, wherein the packet of ions closest to the exit have the lowest (average) m/z. The next packet of ions further within the separation region 201 will have a higher (Average) m/z, with packets of ions still further within having a higher still (average) m/z and so on. As such, each packet of ions may span a different m/z range. In some embodiments, the m/z range for each ion packet separated in the separation region 201 may overlap with other ion packets. That is, ions of a given m/z (or ion mobility) may be divided between two or more ion packets (depending on the m/z range for the ion packets).

Thus, the packets of ions may be output from the ion scheduling device 200 sequentially in order of m/z. For example, for a m/z range of interest of 300 to 900 m/z and a m/z extraction window width of about 100 Th, the first packet of ions (lowest m/z) may have a range of 300 to 400 m/z. The second packet of ions may have a range of 400 to 500 m/z, the third packet having a range of 500 to 600 m/z and so on.

The extracted packets of ions may exit the ion scheduling device 50 and travel to the downstream quadrupole mass filter 70 (or other ion selection device) for further ion selection. The DC gradient applied to the ion scheduling device 50 may then be further reduced to the next m/z extraction window in the sequence and so on until the m/z range of interest is exhausted (i.e. m/z extraction windows spanning the m/z range of interest have each been emptied of ions), whereupon the accumulation region 202 may be once again emptied, and the cycle repeated.

Thus, in each cycle of the linear ion scheduling device 200, ions may be output from the linear ion scheduling device 200 according to their m/z. That is to say, ions may be output from the linear ion scheduling device 200 in a sequence of packets, each sequential packet of ions generally increasing m/z. In particular, ions may be extracted from the linear ion scheduling device 200 using a sequence of m/z extraction windows. It will be appreciated that the general techniques of ion scheduling described in relation to the linear ion scheduling device 200 may also be applied to the bypass ion scheduling device 300 of FIG. 3B and the multiple-ion trap ion scheduling device 400 of FIG. 3C.

As shown in FIG. 3A, ions may be output from the linear ion scheduling device 200 in approximate m/z order of the ion packets, wherein they are further isolated by quadrupole mass filter 70. The fill time (accumulation time, or injection time) for the quadrupole mass filter 70 may be controlled by the controller. In particular, the fill time may be controlled based on known properties of the group of ions being injected into the quadrupole mass filter 70 from the ion scheduling device 50 in order to try to improve the dynamic range of the spectrometry system, as described in further detail below.

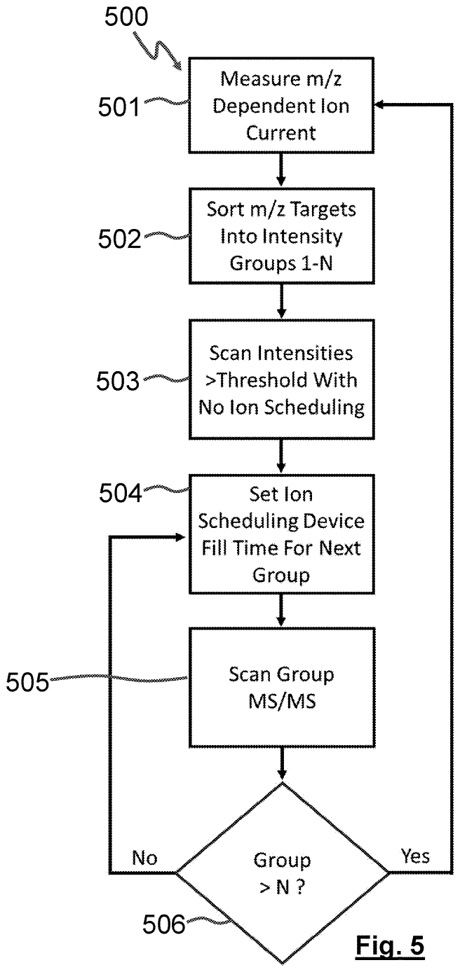

Next a method 500 of scheduling ions for analysis over a m/z range of interest will be described with reference to the flow chart of FIG. 5. The method 500 may be performed by the mass spectrometry system 1 of FIG. 4.

In step 501 the mass spectrometry system 1 obtains data indicative of the m/z and associated intensities of the ions across the m/z range of interest. For example, the mass spectrometry system 1 may obtain the data by performing a mass analysis of the ions being generated by the ESI source 20. The mass analysis may be a mass analysis performed in the MS1 domain across the m/z range of interest (i.e. a survey analysis of the ions to be analysed). The mass analysis may be performed, for example by the orbital trapping mass analyser or the TOF mass analyser 150. In some embodiments, data derived from other mass analyses performed by the mass spectrometry system 1 may be used to obtain data indicative of the m/z and associated intensities of the ions across the m/z range of interest. For example, data generated by an Automatic Gain Control (AGC) measurement may be used. In some embodiments, the mass analysis may be performed in order to provide an impression of the distribution of ion species across the m/z range of interest. As such, the survey analysis performed may be performed at a relatively lower resolution, and/or having a relatively short associated fill time, and/or in a relatively short duration compared to other mass analyses performed by the mass spectrometry system 1.

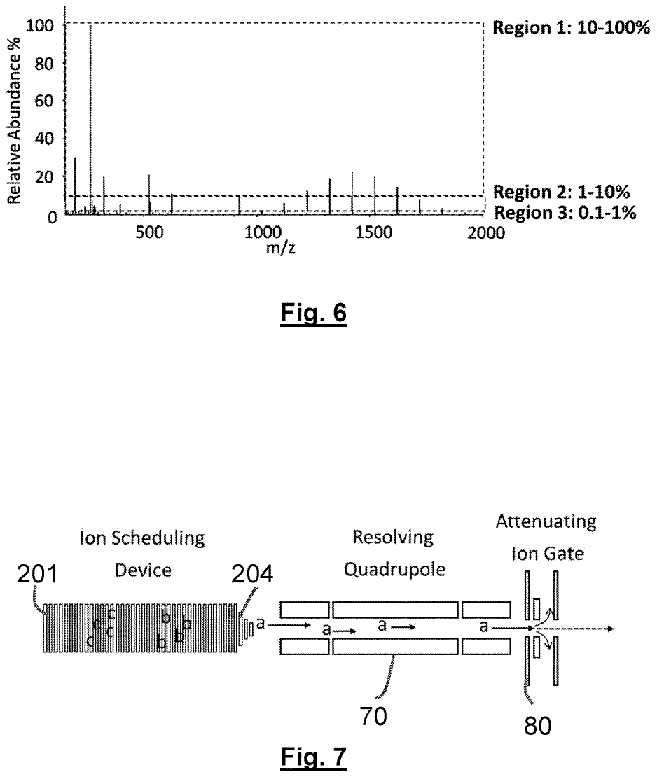

FIG. 6 shows a graph of a typical mass spectrum which may be obtained as a result of a survey analysis. As shown in FIG. 6, various peaks corresponding to ion species are distributed across a m/z range of interest (10 to 2000 m/z).

As part of step 501, the method also obtains a plurality of target m/z values or plurality of target m/z ranges to be analysed. Ions having the target m/z or plurality of target m/z ranges may be scheduled by the method 500 of scheduling ions according to this disclosure. Depending on the type of analysis to be performed (e.g. DIA, DDA, HDR), the targets may be either target m/z (i.e. targeting individual ion species) or target m/z ranges (i.e. targeting ions falling within a m/z window). The number of targets may depend on the analysis to be performed. For example, for a DDA analysis, the top 10, 20, 30 or 40 most intense ion species may be targeted. For a DIA analysis, the m/z range of interest may be split into e.g. at least 50 target m/z ranges to be analysed.

In step 502, the method assigns each target m/z or target m/z range to one of a plurality of groups (e.g. a first group or a second group). Each target is assigned based on the intensity of the ions associated with the m/z of the target m/z or target m/z range. For a target m/z range, the intensity considered when assigning a group may be the average intensity across the target m/z range for example. Each group into which targets are assigned has an associated intensity range (or intensity threshold(s)). For example, the first group having the most intense targets may be defined by a first intensity threshold. Target m/z having an associated intensity (or target m/z ranges having an average intensity) greater than the first intensity threshold may be assigned to the first group. The second group may be defined by the first intensity threshold and a second intensity threshold. As such, targets having an associated intensity of no greater than the first intensity threshold but greater than the second intensity threshold may be assigned to the second group. A third group may be defined by second and third intensity thresholds and so on. Thus, it will be appreciated that each group may span an intensity range.

In some embodiments, the intensity thresholds may be specified by absolute ion intensities. In some embodiments, the intensity thresholds may be normalised to the intensity of the ions obtained from the survey analysis. That is to say, the first, second, and third intensity thresholds may be specified as a percentage of the intensity of the most intense ion species (i.e. the relative abundance of each ion species). For example, the first intensity threshold may be about 10% of the intensity of the most intense ion species. The second intensity threshold may be about 1% of the intensity of the most intense ion species. The third intensity threshold may be about 0.1% of the intensity of the most intense ion species. In some embodiments e.g. for a DDA analysis, targets falling below a minimum intensity threshold may be indistinguishable from noise (e.g. ions below about 0.1% of the intensity of the most intense ion species) and therefore may not be assigned to a group.

The graph of FIG. 6 also shows one example of separating targets into groups. In FIG. 6, each peak corresponding to an ion species is assigned to a group based on the relative intensities (or relative abundance) of each ion peak. Each ion peak, or target m/z above a relative abundance of 10% is assigned to the first group. Each target m/z having a relative abundance of at least 1% and no greater than 10% is assigned to the second group. Each target m/z having a relative abundance of at least 0.1% and no greater than 1% is assigned to the third group. It will be appreciated that the number of groups and the distribution of ion intensities between the groups shown in FIG. 6 is only one possible example, and that other intensity distributions and/or group numbers may be used.

In step 503, target m/z or target m/z ranges within the first group may be analysed. In the embodiment of method 500, for each target m/z or target m/z range of the first group, ions are transferred to the mass filtering device 70 without undergoing separation in the ion scheduling device. As such, the subset of ions for each target m/z or target m/z range of the first group may be selected from the entire ion population using the quadrupole mass filter 70. As the target m/z values or target m/z ranges of the first group are associated with relatively high intensity ions, a relatively short fill time of the quadrupole mass filter 70 may be used to obtain a suitable quantity of ions for each subset of ions to be output. Moreover, as all targets are relatively high intensity species, the effect of one high intensity ion species suppressing another ion species is limited, such that there may be limited advantages to utilising the ion scheduling device 50 to further separate the targets of the first group. Rather, the cycle time of the method may be improved by not operating the ion scheduling device 50 for the first group.

The subsets of ions output by the quadrupole mass filter 70 may then be transferred to the orbital trapping mass analyser 110 or the TOF mass analyser 150 for mass analysis in the e.g. MS1 or MS2 domain as described above. Where MS2 analysis (or MS3, or MSⁿ) is desired, the ions for each target analysis may be fragmented prior to analysis. The specific mass analysis to be performed will depend on the type of mass spectrometry experiment being performed (e.g. DIA, DDA, HDR etc.).

For an ion scheduling device 50, the cycle time for each ion scheduling cycle may relate to the speed of the ion scheduling device 50, the desired signal amplification, any need to limit ion accumulation time to prevent overloading, and the number of separate ion packets to be output in the cycle. For relatively low intensity ion populations (e.g. for targets of the second group) it is generally desirable to maximise the fill time and number of target windows. As such, a relatively slow cycle may result, but gives results in improved signal amplification. In some embodiments, in particular for the first group of targets, it may be possible to operate the ion scheduling device 50 more rapidly when there are fewer target windows, for example by adjusting voltage to skip over unmeasured areas or reduce resolving power. This is particularly advantageous when a few intense species are measured, which require lower amplification, lower ion accumulation time and fewer target windows. Thus, in some embodiments, no more than: 10, 7, 5, or 3 target m/z or target m/z ranges may be assigned to the first group. Thus, the first ion scheduling cycle may be optimised to be performed in a limited time, thereby freeing up additional analysis time for the less intense targets.

In steps 504, 505, and 506, further groups of target m/z values or target m/z ranges are scheduled for analysis. For second and subsequent groups, the ion scheduling device 50 may be used to separate the ions into packets according to their m/z or ion mobility. For each group, a fill time of the ion scheduling device 50 may be set based on an intensity associated with the ions of the group. As such, a fill time for selecting and outputting ions for the second group of target m/z or target m/z ranges may be longer than a fill time for selecting and outputting ions for the first group of target m/z or target m/z ranges. Thus, the packets of ions output by the ion scheduling device 50 may include a larger population of ions for targets in the second group than would otherwise be available.

For target m/z or target m/z ranges of the second group (or indeed any other group), a plurality of ion scheduling cycles may be performed in order to analyse all the target m/z or target m/z ranges of the group. Each ion scheduling cycle may comprise the ion scheduling device receiving ions, wherein the ion scheduling device 50 separates the ions into a plurality of packets of ions according to their m/z or ion mobility and outputs the plurality of groups sequentially. Each packet of ions output by the ion scheduling device 50 has an associated m/z range or ion mobility range. For each ion packet output by the ion scheduling device 50, the quadrupole mass filter 70 may select a subset of the ions based on a target m/z or target m/z range. Where two or more target m/z or target m/z ranges of a group (e.g. the second group) fall within a m/z range or ion mobility range of a packet of ions, a plurality of ion scheduling cycles (e.g. a plurality of second ion scheduling cycles) are performed such that no more than one subset of ions is selected from each packet of ions. By separating ions into packets separated by m/z or ion mobility prior to selecting subsets of ions for each target m/z or target m/z range, the effect of relatively intense precursor on dynamic range may be reduced or eliminated. As such, each subset of ions output for the second group (and subsequent groups) may have an increased ion population resulting from increased fill times, thereby improving the dynamic range of the subsequent mass analyses.

As shown in step 505, subsets of ions for each target m/z or target m/z range for the second group (or a subsequent group) are output from the ion scheduling device 50 and mass filter 70 and are mass analysed in MS1 or MS2 as appropriate.

In some embodiments, the ions to be scheduled for analysis may be scheduled for different types of analysis (e.g. MS1, MS2, MS3, or MSⁿ). In embodiments where there are e.g. MS3 analyses to be performed, the AGC target for the MS3 analyses may be significantly higher than the AGC target for e.g. MS1 or MS2 analyses to allow for sufficient surviving ions after the second stage of fragmentation. In this case the grouping of scans should take into account not only the intensity of the peak, but the differing number of ions desired by the method. As such, in some embodiments obtaining a plurality of target m/z or plurality of target m/z ranges to be analysed comprises obtaining a target ion current for one or more the target m/z or target m/z ranges. Consequently, assigning each target m/z or target m/z range to a first group or a second group may be based on the list of ion intensities and associated m/z of the ions, the target ion current, and the intensity threshold, wherein a target m/z or target m/z range assigned to the first group may be reassigned to the second group based on the target ion current. For example, where a relatively intense target m/z is scheduled for a MS3 analysis, the relatively intense ion species might be grouped with lower intensity ion species scheduled for MS2 analyses, as the accumulation time in the ion scheduling device 50 for both analyses may be similar.

As shown in step 506, once all target m/z values or target m/z ranges are acquired for e.g. the second group, the method may then acquire ions for target m/z values or target m/z ranges of the next group until all desired groups have been acquired (e.g. three groups for the example of FIG. 6). Once all targets of all groups have been acquired, one cycle of the method 500 of scheduling ions is complete. As shown in FIG. 5, the method 500 of scheduling ions may then be repeated. For example, the cycle of method 500 may be performed a plurality of times as a sample elutes from a chromatographic column in order to accurately characterise the sample.

In essence, methods of this disclosure appreciate that typically multiple cycles of an ion scheduling device 50 may be performed in order analyse all target m/z or target m/z ranges. Accordingly, the fill level of the ion scheduling device 50 may be varied between ion scheduling cycles. Relatively intense ion species may be output on one or more first ion scheduling cycles with relatively low fill times, where they will be correspondingly (relatively) attenuated. Relatively lower intensity precursors may be output on one or second ion scheduling cycles having longer fill times, up to the limited ion capacity of the ion scheduling device 50 in order to improve the dynamic range of the ion species output by the method 500.

Methods of scheduling ions according to this disclosure may specify the number of target m/z values or target m/z ranges to be assigned to each group, or each ion scheduling cycle within each group. The number of target m/z values or target m/z ranges per ion scheduling cycle of the ion scheduling device 50 may depend on a separation resolution of the ion scheduling device, as well as the ion capacity of the ion scheduling device 50. For example, if the ion scheduling device 50 is separating ions into ion packets each covering no less than e.g. 10% of the m/z range of interest, then it follows that no more than 10 target m/z values or target m/z ranges may be analysed per ion scheduling cycle.

For example, in a method of scheduling ions for a DIA methodology, it may be desired to analyse ions over a m/z range of 100-1000 m/z. Accordingly, the ion scheduling device 50 may be configured to output packets of ions spanning a m/z range of about 100 Th each (e.g. packets spanning 100-200 m/z, 200-300 m/z . . . 900-1000 m/z). The quadrupole mass filter may then select subsets of ions with a 10 Th isolation window. It will be appreciated that the quadrupole cannot select target m/z ranges in the regular sequence 100-110, 110-120 etc, but instead takes a single shot from each extracted range per cycle: 100-110, 200-210 . . . 900-910 then 110-120, 210-220 . . . 910-920 in the next cycle, and so on until all DIA windows are measured. If each ion scheduling cycle may be completed in ~100 ms, then a full DIA cycle would take about a second.

To further improve the ion transmission efficiency of the method of scheduling ions, subsets of ions may be selected from a central range of each packet of ions. That is, a central range of each packet of ions may be aligned with target m/z or target m/z ranges to be output for the ion scheduling cycle. Ion species at the fringes of each ion packet in the ion scheduling device 50 may be subject to transmission losses from the ion scheduling device 50.

In order to allow all e.g. all DIA target m/z ranges to be analysed, whilst selecting from a central region of each group of ions, the DIA methodology may further comprise shifting the m/z ranges of each packet of ions separated by ion scheduling device 50 for different ion scheduling cycles. That is, a central m/z of each packet of ions output by the ion scheduling device may be shifted such that the central m/z is aligned with a central m/z of a DIA window to be extracted in the ion scheduling cycle. As such, for each of the plurality of ion scheduling cycles, a deviation of the ion scheduling device is varied such that the plurality groups of ions span a different m/z range or ion mobility range.

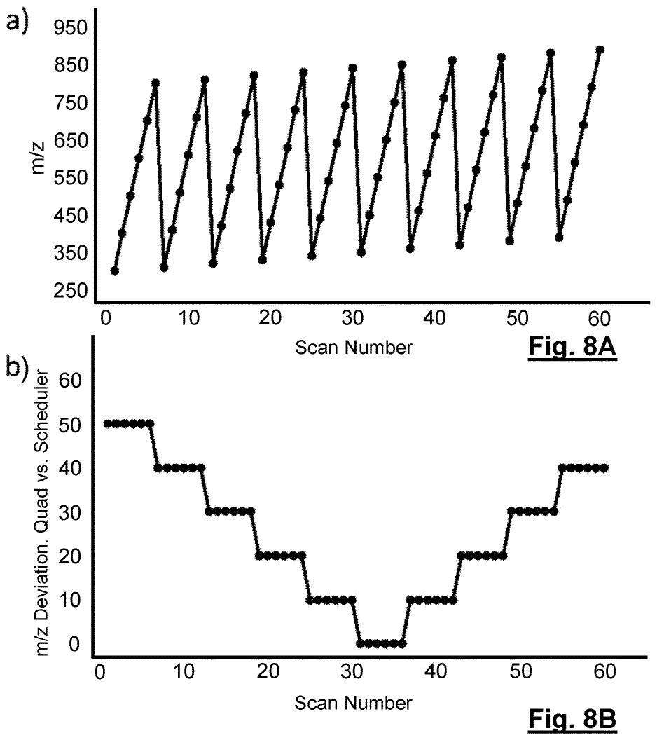

As a simplified explanation of this concept, FIG. 8A shows a simplified series of analysis to be performed as part of a 60 window DIA methodology covering a m/z range of interest of 300-900 m/z with 10 Th wide target m/z ranges of ions to be analysed. FIG. 8B shows the deviation in m/z between the centre of the ~100 Th extraction window of the ion scheduling device 50 and the centre of the quadrupole isolation window. In the example of FIG. 8A, the target m/z ranges to be analysed in the first ion scheduling cycle are 300-310, 400-410, 500-510, 600-610, 700-710, and 800-810. In practice, the target m/z ranges for each ion scheduling cycle may not be evenly distributed across the m/z range of interest, allowing the ion scheduling device to align each ion packet m/z range with the target m/z range. Nevertheless, the ion scheduling device 50 may optimise the deviation of the ion scheduling device 50 for each ion scheduling cycle to align a central m/z of each ion packet with the corresponding target m/z or target m/z range as closely as possible. For example, the m/z ranges of each ion packet may be shifted in order to minimise an average difference between a central m/z of each ion packet and the corresponding target m/z or a central m/z of a target m/z range.

The deviation of the ion scheduling device 50 to vary the m/z range of each packet of ions output by the ion scheduling device 50 may be implemented as a shift in the timing or magnitude of the AC or DC voltage ramp used to separate the ions. For example, for the linear ion scheduling device 200 as shown in FIG. 3A, the deviation may be accomplished via a shift in the applied timings of the AC or DC voltage ramp. For devices that constantly fill into an array of traps, such as the multi-trap ion scheduling device 400 shown in FIG. 3C the deviation of the ion scheduling device 50 may be varied over several ion scheduling cycles to account for the parallel filling of the ion traps 402.

As will be appreciated from the simplified example, when assigning the target m/z or m/z ranges into groups, the ion intensity between different targets may vary significantly. In general, methods of this disclosure provide a plurality of ion scheduling cycles, where individual ion scheduling cycles serve targets with similar intensity. Furthermore, as targets of similar intensity will often not be evenly distributed across the m/z range of interest, the ion scheduling device 50 may also have to ensure that there is sufficient m/z (or ion mobility) distance between targets in the same cycle of the ion scheduling device 50 so as not to be affected by losses from overlapping extraction windows (which may adversely impact dynamic range). Furthermore, it is preferable for the maximum number of targets to be scheduled in each ion scheduling cycle in order to operate the mass spectrometry system 1 efficiently.

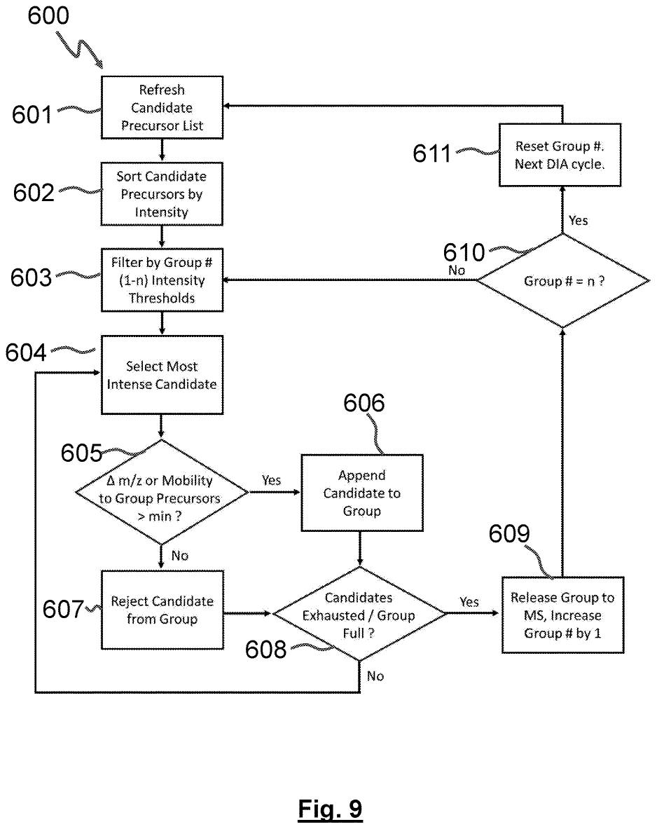

In essence, the assigning of target m/z values or target m/z ranges to different groups, and different ion scheduling cycles within each group is an optimisation problem. FIG. 9 shows a flow chart of one iterative method 600 for assigning targets according to an embodiment of the disclosure. The method 600 of FIG. 9 may be performed by the mass spectrometry system 1 of FIG. 4.

In step 601 a candidate precursor list of ion intensities and associated m/z is obtained. This list may be generated by some method such as a full MS1 analysis for the m/z range of interest or survey analysis as described above. This candidate precursor list may comprise ion target m/z values or of multiple ion species within relatively narrow target m/z ranges.

In step 602 the targets may be sorted by intensity and in step 603 may be assigned to a group based on one or more intensity thresholds. Each intensity threshold (or intensity range) may be specific to a group. The intensity thresholds may be fixed, for example a first intensity threshold for the first group may require target to have an ion current of >1×10⁷ ions per second. In some embodiments, the intensity thresholds may be dynamic, based on the number of groups specified for the methodology and the range of ion intensities. The aim of assigning targets to different groups is to prevent targets having low intensity ions being sorted into the same group (and consequently the same ion scheduling cycle) with very high intensity ions.

In step 604, the method 600 proceeds to start scheduling ions for targets from the first group. The first ion scheduling cycle may be populated, from the most intense targets downwards. As shown in step 605, each subsequent target may be added (step 606) to the pending ion scheduling cycle if it fulfils a set of specified conditions. The specified conditions for an ion scheduling cycle may comprise a minimum spacing (a minimum m/z spacing or minimum ion mobility spacing) from other targets added to the pending ion scheduling cycle. If the target m/z or target m/z range is too close to another target m/z or target m/z range already added to the pending ion scheduling cycle, the target m/z may be rejected (step 607). The method may then proceed to step 608 where it is checked to see if there are any other target m/z values or target m/z ranges within the group which have not yet been considered for scheduling as part of the pending ion scheduling cycle (and either scheduled or rejected. If further targets are available for consideration, the method may repeat steps 605-608 to consider additional targets. In step 608, the method may also determine that an ion scheduling cycle has the maximum number of allowable targets already scheduled. For example, where an ion scheduling device 50 is configured to separate ions into no more than 10 ion packets, the maximum number of scheduled targets may be 10.

Once the pending ion scheduling cycle is full (i.e. the maximum number of targets are scheduled), or no further targets are available for consideration, the method 600 may proceed to step 609 where the ion scheduling device 50 and quadrupole mass filter 70 proceed to separate the ions into packets and select subsets of ions in accordance with the target m/z values or target m/z ranges scheduled. One or more fill times for e.g. the ion scheduling device 50, quadrupole mass filter 70 etc. may be adjusted based on the intensities of the ions within the group/ion scheduling cycle. The scheduled ions are then output for analysis by the orbital trapping mass analyser 110 or TOF mass analyser 150.

Once the ion scheduling device 50 has output ions for one ion scheduling cycle, the next ion scheduling cycle may be populated. For the next ion scheduling cycle, previously rejected targets may be reconsidered, starting with the most intense targets (steps 610, 603, 604). The ion scheduling cycles may be populated until all targets from a group are exhausted, before moving onto targets from the next group. Once all groups for have been analysed, the candidate precursor list may be refreshed, and the assignments begin anew.

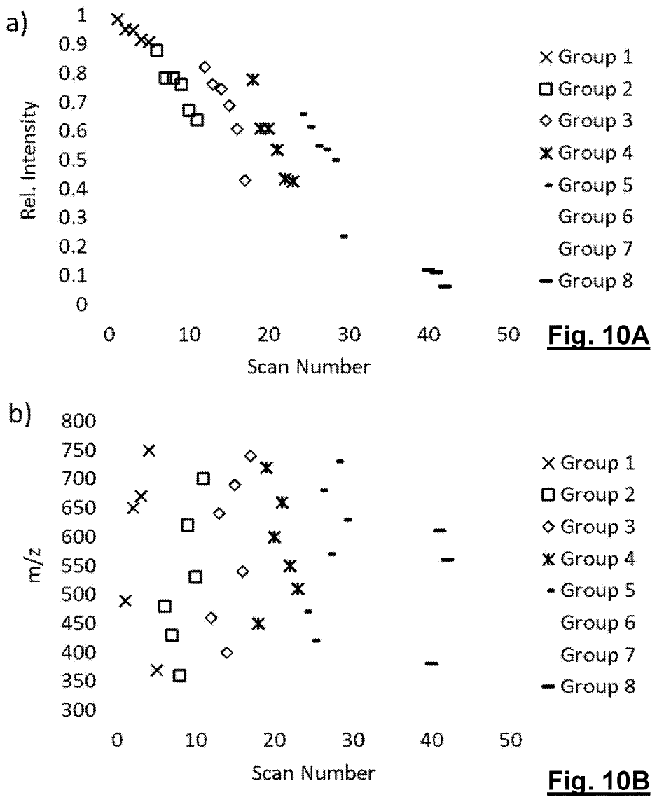

FIGS. 10A and 10B shows an example of the method of FIG. 9, sorting 42 DIA windows (10 Th, overall m/z range of interest 350-760), with a random intensity distribution, into optimized groups based on intensity and with ions in the same groups having Δm/z>50. FIG. 10a shows a plot of intensity vs scan (analysis) number, showing the grouping of similar intensities together and the order in which the targets are scheduled for analysis. FIG. 10b shows the m/z target vs scheduled analysis number. In this example, Group 1 is allowed to ignore the mass distance rule (Δm/z>50), as these ions represent targets that are too intense for the ion scheduling device 50, and that may be better measured by traditional MS/MS processes, preferably using a bypass region 54 in the ion scheduling device 50. If there is no bypass, these targets may preferably be scheduled adjacent to a regular full MS or AGC survey scan, when the regular ion scheduling operation is not performed.

The method 600 of FIGS. 9, 10A and 10B show the target groups being processed by the mass spectrometry system 1 in order of intensity from most intense to least intense (i.e. group 1 then 2 then 3 etc). In some embodiments, it may be preferable that the lower intensity, higher numbered groups, are analysed first by the mass spectrometry system 1, as otherwise these ion species may no longer be detectably eluting by the time the instrument comes to them. It will also be appreciated that some ion species identified in the survey analysis may be growing in intensity with time (i.e. the species being detected at the beginning of elution rather than tail) and may become more intense with a delay to processing. Such cases may be identified based on their appearance or not in previous cycles/survey analyses. Apex detection algorithms are also known which may predict peak shapes of ion species as they are detected in previous analyses or survey analyses, which may be used to update the list of intensities obtain for the ion species.

Accordingly, the methods and mass spectrometry systems 1 according to this disclosure aim to improve the dynamic range of instruments incorporating an ion scheduling device 50 by sorting ions into the ion scheduling device 50 based broadly on intensity distribution. This reduces or eliminates overloading of the ion scheduling device 50 with relatively intense targets and the underfilling of the ion scheduling device with relatively sparse targets. Further, methods according to this disclosure may also speed up acquisition of targets by reducing ion accumulation time for many relatively intense ion species.

Overloading of the ion scheduling device 50 when dealing with low intensity precursors may possibly be prevented with pre-filtering, or separation dependent attenuation within the device. As such, the methods of scheduling ions according to this disclosure may be combined or supplemented with any other methods of precursor ion sorting and filtering, for example dynamic exclusion, exclusion based on other parameters such as resolution, and use of inclusion lists containing targets (for example where high sensitivity measurement of standards and known biomarkers is integrated into a DDA/DIA method).

Methods of ion scheduling may have reduced dynamic range when very intense ions intermingle with low intensity ions. In such circumstances, the very intense ion species overfill the ion scheduling device 50 and may prevent longer accumulation times being used to obtain increased signal strength for the low intensity ion species.

To address this, in some embodiments, the ion selection device 50 may comprise a first ion scheduling device and a second ion scheduling device (not shown in FIG. 4). As such, the first ion scheduling device may be configured to separate the ions into a plurality of first packets of ions based on the m/z or ion mobility of the ions, and to output the first packets of ions sequentially in order of their m/z or ion mobility to the second ion scheduling device. The second ion scheduling device may then be configured to separate each packet of ions into plurality of second packets of ions based on the m/z or ion mobility of the ions, and to output the second packets of ions sequentially in order of their m/z or ion mobility. In such an embodiment, the first, upstream ion scheduling device may have a higher ion capacity than the second ion scheduling device. Thus, the first ion scheduling device may accumulate a relatively large quantity of ions, and then release them in rough order of m/z. The second ion scheduling device may then subdivide these narrower m/z ranges into more finely resolved packets of ions in the manner as discussed above. The fill time of the second ion scheduling device may be controlled for each m/z range of ion received from the first ion scheduling device in order to improve the dynamic range of ions scheduled.

Another solution for addressing the intermingling of very intense ions and low intensity ions is to use a multi-trap ion scheduling device 400, for example as shown in FIG. 3C. Multi-trap ion scheduling devices 400 are relatively resistant to such intermingling, as a single high intensity ion species can only flood one ion trap 402, leaving the remainder free. As such, methods of scheduling ions may also be performed using a multi-trap ion scheduling device 400. For the multi-trap ion scheduling device 400, ions of different m/z (or ion mobility) may be separated orthogonally (i.e., orthogonally to the general linear direction of the ion scheduling device) by a plurality of RF electrodes 406 of the multi-trap ion scheduling device 400. The RF electrodes 406 separate the ions orthogonally in a similar manner to the RF electrodes 206 of other ion scheduling devices through a combination of a T-wave and a DC potential. Ions are also directed along the axial length of the ion scheduling device 400 such that the ions are each directed into one of a plurality of ion traps 402 as the ions transit an ion separation region 401 of the multi-trap ion scheduling device 400. Ions of different m/z take different paths through the ion separation region 401 and are therefore directed to the different ion traps 402. Ions are confined in the lateral direction (transverse to the axial direction of ion travel) by the RF electrodes 406 and DC guard electrodes 410, 412 provided on opposing sides of the multi-trap ion scheduling device 400.

In generalised terms, each ion trap 402 may define an outlet allowing the ions trapped within the ion trap 402 to exit the ion separation region 401. There can be two, three, four or more ion traps 402, with each being used to permit ions of a respective m/z extraction window to exit the ion separation region 401. Each m/z extraction window may span a m/z range, thereby allowing a packet of ions to be output in accordance with the methods discussed above. The plurality of m/z extraction windows provided by the plurality of ion traps 402 may span the m/z range of interest. For example, for a m/z range of interest of 300-900 m/z, the five ion traps 402 may have m/z acceptance windows of 300-420 m/z, 420-540 m/z, 540-660 m/z, 660-780 m/z, and 780-900 m/z.

The range of m/z of ions that pass through each ion trap 402 can be adjusted or tuned, for example through appropriate selection of voltages applied by the electrode arrangements and/or by adjustment of gas flows within the separation region. Thus, ions of a given m/z could be directed to a certain ion trap 402 of the plurality of ion traps 402 under certain conditions but could be directed to a different ion trap 402 under other conditions. As such, the voltages applied to the ion traps may be subject to a deviation in for each ion scheduling cycle in order to ensure that the subset of ions to be selected from each ion packet is centred in the packet as discussed above.

The plurality of ion traps 402 are preferably spaced apart in direction transverse to the axial length of the multi-trap ion scheduling device 400. Thus, the ions that separate in the transverse direction are divided into packets of ions corresponding to m/z extraction windows of the ion traps 402 of the multi-trap ion scheduling device 400.

An additional potential (e.g. a DC force) may be applied to the multi-ion trap ion scheduling device 400 to pull ions towards the exits along the axial length of the device 400 (i.e. horizontally in FIG. 3C). For example, a DC gradient may be applied to a DC-only top plate PCB (not shown in FIG. 3C), or a shaped counter-electrode (if RF carpet type), or additional DC electrodes mounted between the RF electrodes 406, or by shaping of the RF electrodes 406. In the embodiment of FIG. 3C, the individual RF electrodes 406 may extend along the axial length of the multi-trap ion scheduling device 400, i.e. the electrodes may extend towards the outlets of the ion traps 402, or are orthogonal to the direction in which the plurality of ion traps are spaced apart. Therefore, the RF electrodes 406 may have the travelling wave/opposing DC applied directly to them in order to separate the ions into ion scheduling groups. Further configurations of a multi-ion trap ion scheduling device 400 are described in GB 2312733.5, the contents of which are herein incorporated by reference.

In some embodiments incorporating multi-trap ion scheduling devices 400, ions may be proportionally split between more than one ion trap due to the separation resolution of the multi-trap ion scheduling device 400. In such circumstances, for one or more target m/z or target m/z ranges, the ion scheduling device outputs ions from two or more ion traps 402 simultaneously to form a packet of ions. This may be particularly beneficial for relatively low intensity ion species, or for improved accuracy of quantitation. A signal correction function may be provided to account for how ion signal is split between multiple ion traps 402, which may be a calibrated function.

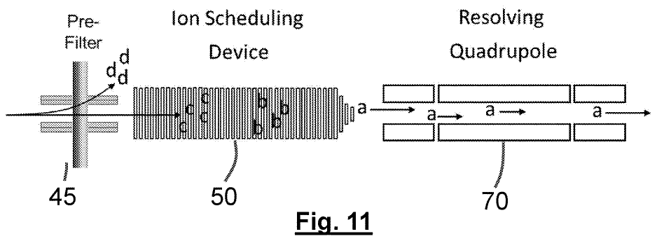

Another method for further reducing intermingling of high intensity precursors is to provide an upstream mass filtering device 45, such as a small resolving quadrupole pre-filter upstream of the ion scheduling device 50. For example, FIG. 11 shows a schematic diagram of an ion scheduling device 50, a quadrupole mass filter 70 and an upstream mass filtering device 45. The quadrupole mass filter 70 and ion scheduling device 50 may be arranged as described above in relation to FIG. 4. The ion scheduling device 50 may be any of the ion scheduling devices described herein, for example the linear ion scheduling device 200. Upstream mass filtering device 45 may be a further quadrupole mass filter, often referred to an injection filter, or pre-filter.

The upstream mass filtering device may provide for the exclusion of one or more relatively high intensity precursors from one or more cycles of the ion scheduling device 50. As such, method 500, for example as part of step 502, may identify target m/z or target m/z ranges to be selectively removed when analysing the second group of targets. Targets to be selectively removed may be selected on the basis of very high intensity (e.g. above a predetermined threshold intensity).

In effect, ions of a high intensity may be excluded from ions input to the ion separation path 52 by means of a notch mass filtering device. Such a device may reject or attenuate a relatively narrow m/z range from the m/z range of interest provided to the ion separation device for e.g. the second ion scheduling cycles. As such, the notch mass filtering device may be configured to remove “notches” out of the ion population m/z range. One such notch mass filtering device comprises an additional RF oscillator which may be applied to a quadrupole ion guide, or the upstream mass filtering device 45 of FIG. 11, in resonance to the oscillations of target m/z ions. Such a notch mass filtering device is further described in at least Miller, P. E., & Denton, M. B. (1990), “A notch rejection quadrupole mass filter”, International journal of mass spectrometry and ion processes, 96(1), 17-26). In some embodiments, multiple notches may be applied to remove two or more relatively intense species from the m/z range of interest through application of multiple additional sinusoidal waveforms. Such waveforms may be used to induce resonant ejection of multiple high intensity species without greatly harming the wide mass range of target species, for example as described further in Belov, M. E., Nikolaev, E. N., Anderson, G. A., Auberry, K. J., Harkewicz, R., & Smith, R. D. (2001), “Electrospray ionization-Fourier transform ion cyclotron mass spectrometry using ion preselection and external accumulation for ultrahigh sensitivity” Journal of the American Society for Mass Spectrometry, 12(1), 38-48).

Thus, the upstream mass filtering device 45 may supply a reduced m/z range to the ion scheduling device 50, cutting out some or all relatively intense precursors (e.g. all targets from the first group). Such filtering may compress the m/z space measured and thus restrict the number of separate packets that may be output per cycle. Nevertheless, the technique may be beneficial to separate lower intensity ion species for analysis with improved dynamic range.

While FIG. 11 shows an upstream mass filtering device 45 operating as a band stop m/z filter, it will also be appreciated that some ion scheduling devices 50 may also operate as bandstop filters by themselves. For example, the DC gradient of the ion scheduling devices 200, 300 of FIGS. 3A and 3B may reject ions if the m/z of the ions is too high, while low m/z ions may be pushed forward by the T-Wave over the DC barrier. Normally the ion scheduling device 50 would be set to put the desired limits of the m/z range of interest at the limits of the ion scheduling device 50 but this could be varied to exclude some ion species if desired.

Methods of scheduling ions according to this disclosure may also be applied to a High Dynamic Range (HDR) method of mass spectrometry. In general, the HDR or Boxcar scanning method splits the full m/z range of interest into a series of separate quadrupole isolation windows, either pre-programmed or generated dynamically based on the location of intense peaks. These quadrupole isolation windows are then accumulated separately into the C-Trap 100 and injected together into the orbital trapping mass analyser 110. These separate windows are lossy in the same way conventional MS2 signal acquisition is lossy. Accordingly, methods of ion scheduling according to this disclosure can be applied to a HDR methodology to reduce ion losses and improve dynamic range and/or cycle time.

Thus, a method of ion scheduling, for example as shown in FIG. 5 may be used to schedule target m/z or target m/z ranges for a HDR method of mass spectrometry. Thus, as shown in FIG. 5, a series of target m/z ranges may be obtained based on a survey analysis and may be listed in order of intensity. The most intense peaks (target m/z) may be assigned to a first group and scheduled for analysis. These target m/z may be accumulated in C-trap 100 and analysed together in a single mass analysis, e.g. using orbital trapping mass analyser 110 to produce a mass spectrum associated with the first group.

The remaining target m/z ranges may be sorted into groups based on m/z region and intensity, for example as described in relation to FIG. 7. As the target m/z ranges may be relatively wide, with the m/z range of interest split into e.g. no more than: 20, 15, 12 or 10 target m/z ranges, rather than ~100 for a typical DIA analysis, fewer cycles of the ion scheduling device may be required for a HDR method. The ions of the second group may be accumulated and mass analysed in the MS1 domain to produce one or mass spectra of ions assigned to the second group. A HDR mass spectrum may then be assembled from the mass spectra of the ions assigned to the first and second groups.

The above HDR methodology accumulates subsets of ions and performs a single MS1 analysis for each group of targets. Such a technique may be particularly applicable to mass analysers with a relatively long cycle time, such as the orbital trapping mass analyser 110, where the analysis duration is of at least a similar duration to the time taken to accumulate all the ions prior to the HDR MS1 analysis (e.g. in excess of 100 ms). For relatively fast mast analysers, for example TOF mass analyser 150, that may obtain a mass spectrum in about 5 ms, it may be advantageous to perform multiple MS1 analyses as the ions of each target m/z range are accumulated. For example, one or more subsets of ions may be accumulated in C-trap 100 and then sent for MS1 analysis at the TOF mass analyser 150. As such, for each ion scheduling cycle one or more subsets of ions accumulated in the ion trap may be analysed in the MS1 domain to generate a partial HDR mass spectrum. The full HDR mass spectrum may then be assembled from the accumulated plurality of partial mass spectrums covering different target m/z and target m/z ranges. Advantageously, by splitting the full MS1 analysis into a plurality of partial MS1 analyses, targets for MS1 analysis may be scheduled by the method of ion scheduling which can be interleaved with other targets for different purposes e.g. MS2 analysis.

In some embodiments, in particular for HDR methods, an attenuating ion gate 80 may be provided downstream of the ion selection device. For example, FIG. 7 shows an attenuating ion gate 80 which may be provided between the quadrupole mass filter 70 and the C-trap 100 in the mass spectrometry system 1 of FIG. 4. The attenuating ion gate 80 to selectively attenuate ions which are identified as being relatively intense in order to selectively remove such ions from a subset of ions output by the quadrupole mass filter 70. Relatively low intensity ions may not be attenuated by the attenuating ion gate 80. The attenuating ion gate may provide for an improved dynamic range of ions output for analysis in a manner similar to HDR or Boxcar scanning methodologies, but in a manner which makes more efficient, or continuous usage of the available ions. As the ion scheduling device 50 outputs ions in order of m/z or linked mobility, the downstream attenuating ion gate 80 may operate on the released ions in sequence. For example, in some embodiments the attenuating ion gate 80 may be an attenuating double ion gate, for example as described in U.S. Pat. No. 8,026,475 B2. Such an attenuating double ion gate may enable linear timing control down to 10 μs, which may allow for accurate attenuation of ions.

As noted above, the quadrupole mass filter 70 may also act as an ion selection device according to this disclosure (i.e. without the presence of an ion scheduling device 50). Methods of ion scheduling according to this disclosure may also be applicable to such mass spectrometry systems as it is efficient for mass analyses to be ordered in sequence of m/z. The ion scheduling technique of this disclosure improved upon simply order targets to be analysed in order of m/z, by assigning ions into groups based on intensity and prioritising the more intense groups.

For example, a quadrupole mass filter 70 may be used as an ion selection device for a DDA method of mass spectrometry incorporating an ion scheduling method according to this disclosure. Thus, the list of m/z targets for the DDA analysis may be sorted into a plurality of groups (e.g. 4 groups), based on intensity thresholds. Each group may have e.g. about 25 targets. The ion population of each group may then be ordered by m/z. This way, relatively high priority intense peaks may all be measured, whilst lower intensity peaks are not automatically skipped. In some embodiments the sorting of target m/z into groups may also take into account a distance of a target m/z to its neighbour.

Thus, according to this disclosure methods of scheduling ions for analysis using a mass spectrometry system 1 are provided in which ions are assigned into groups based on their m/z and relative intensities and scheduled for analysis accordingly.

1. A method of scheduling ions for analysis over a mass to charge (m/z) range of interest, the method comprising:
obtaining a list of ion intensities and associated m/z for the ions to be analysed;
obtaining a plurality of target m/z or plurality of target m/z ranges to be analysed;
assigning each target m/z or target m/z range to a first group or a second group based on the list of ion intensities and associated m/z of the ions and an intensity threshold, wherein the target m/z or target m/z ranges in the first group are associated with higher intensity ions than the target m/z or target m/z ranges in the second group;
using an ion selection device to sequentially select and output ions having target m/z or target m/z ranges assigned to the first group for analysis; and
using the ion selection device to sequentially select and output ions having target m/z or target m/z ranges assigned to the second group for analysis.

2. A method according to claim 1, wherein
the ion selection device has an associated fill time for receiving ions, wherein a fill time for selecting and outputting ions for the second group of target m/z or target m/z ranges is longer than a fill time for selecting and outputting ions for the first group of target m/z or target m/z ranges.

3. A method according to claim 1, wherein
three or more groups of target m/z or target m/z ranges are provided, each group having an associated ion intensity range,
wherein each target m/z or target m/z range is assigned to one of the three or more groups based on the list of ion intensities and associated m/z of the ions.

4. A method according to claim 1, wherein
the ion selection device comprises an ion scheduling device configured to separate the ions into a plurality of packets of ions based on the m/z or ion mobility of the ions, and to output the packets of ions sequentially in order of their m/z or ion mobility.

5. A method according to claim 4, wherein
the ion selection device further comprises a mass filtering device configured to receive each packet of ions; and
for each packet of ions, the mass filtering device selects a subset of the ions based on the plurality of target m/z values or plurality of target m/z ranges.

6. A method according to claim 5, wherein
for each target m/z or target m/z range of the first group, ions are transferred to the mass filtering device without undergoing separation in the ion scheduling device; and
a subset of ions having each target m/z or target m/z range are selected using the mass filtering device.

7. A method according to claim 5, wherein
the ion scheduling device performs a plurality of ion scheduling cycles, wherein each ion scheduling cycle comprises:
the ion scheduling device receiving ions, wherein the ion scheduling device separates the ions into a plurality of packets of ions according to their m/z or ion mobility and outputs the plurality of groups sequentially,
wherein ions having target m/z or target m/z ranges assigned to the first group are output during one or more first ion scheduling cycles, and
ions having target m/z or target m/z ranges assigned to the second group are
output during one or more second ion scheduling cycles.

8. A method according to claim 7, wherein
each packet of ions output by the ion scheduling device has an associated m/z range or ion mobility range, wherein
where two or more target m/z or target m/z ranges of the first group fall within a m/z range or ion mobility range of a packet of ions, a plurality of first ion scheduling cycles are performed such that no more than one subset of ions is selected from each packet of ions.

9. A method according to claim 8, wherein,
target m/z or target m/z ranges are promoted from the second group to the first group in order to increase the utilisation of packets of ions output by the ion scheduling device.

10. A method of scheduling ions for analysis according to claim 1 provided as part of a Data Independent Acquisition method of mass spectrometry, wherein the m/z range of interest is divided into a plurality of target m/z ranges to be analysed,
wherein for the ions of each target m/z range output by the ion selection device, the method further comprises:
fragmenting the ions of each target m/z range; and
mass analysing the ions.

11. A method according to claim 1, wherein
the ion selection device comprises a first ion scheduling device and a second ion scheduling device,
the first ion scheduling device configured to separate the ions into a plurality of first packets of ions based on the m/z or ion mobility of the ions, and to output the first packets of ions sequentially in order of their m/z or ion mobility to the second ion scheduling device;
the second ion scheduling device configured to separate each first packet of ions into a plurality of second packets of ions based on the m/z or ion mobility of the ions, and to output the second packets of ions sequentially in order of their m/z or ion mobility.

12. A method according to claim 11, wherein
an ion capacity of the first ion scheduling device is larger than an ion capacity of the second ion scheduling device.

13. A method according to claim 1, wherein
for the second group of ions, a pre-filter provided upstream of the ion selection device selectively attenuates the ions provided to the ion selection device based on the target m/z or target m/z ranges of the first group.

14. A method according to claim 5, wherein
the ion scheduling device comprises a plurality of ion traps, wherein each ion trap has an associated m/z acceptance window or an associated ion mobility acceptance window, and
the plurality of ion traps output packets of ions in sequence such that the ion scheduling device outputs the packets of ions according to the m/z or ion mobility of the ions.

15. A method according to claim 14, wherein
for one or more target m/z or target m/z ranges, the ion scheduling device outputs ions from two or more ion traps simultaneously to form a packet of ions.

16. A method according to claim 1 when provided as part of a High Dynamic Range (HDR) method of mass spectrometry, the method further comprising:
accumulating ions associated with one or more target m/z or target m/z ranges of the first group output by the ion selection device in an ion trap; and
mass analysing the accumulated ions in the MS1 domain to produce one or mass spectra of ions assigned to the first group;
accumulating ions associated with one or more target m/z or target m/z ranges of the second group output by the ion selection device in an ion trap; and
mass analysing the accumulated ions in the MS1 domain to produce one or mass spectra of ions assigned to the second group; and
assembling a HDR mass spectrum from the mass spectra of ions assigned to the first and second groups.

17. A method according to claim 1, wherein
no more than: 10, 7, 5, or 3 target m/z or target m/z ranges are assigned to the first group.

18. A method according to claim 1, wherein
obtaining a plurality of target m/z or plurality of target m/z ranges to be analysed comprises obtaining a target ion current for one or more the target m/z or target m/z ranges, and
wherein assigning each target m/z or target m/z range to a first group or a second group is based on the list of ion intensities and associated m/z of the ions, the target ion current, and the intensity threshold, wherein a target m/z or target m/z range assigned to the first group may be reassigned to the second group based on the target ion current of the target m/z or target m/z range.

19. A method according to claim 1, wherein
the ion selection device is a mass filtering device which filters the ions and outputs a subset of ions based on having a target m/z or target m/z range for each of the target m/z values or target m/z ranges in the first and second groups.

20. A mass spectrometry system for analysing ions over a m/z range of interest, the mass spectrometry system comprising:
an ion selection device; and
a mass analyser,
wherein the mass spectrometry system is configured to perform the method of claim 1.

21. A method comprising:
obtaining a list of ion intensities and associated ion mobility values for the ions to be analysed;
obtaining a plurality of target ion mobility ranges to be analysed;
assigning each target ion mobility range to a first group or a second group based on the list of ion intensities, the associated mobility of the ions and an intensity threshold, wherein the target mobility ranges in the first group are associated with higher ion intensity than the target ion mobility range in the second group;
using an ion selection device to sequentially select and output ions having target ion mobility ranges assigned to the first group for analysis;
using the ion selection device to sequentially select and output ions having target ion mobility ranges assigned to the second group for analysis; and
separately mass analysing ions of the first and second outputted groups of accumulated ions.
